(19) United States
(12) Patent Application Publication
(10) Pub. No.: US 2026/0238826 A1
(43) Pub. Date: Aug. 13, 2026

(54) Post-Processing Filtering Process Based On Post-Processing Filter Groups

(71) Applicant: Bytedance Inc., Los Angeles, CA (US)

(72) Inventors: Ye-Kui WANG, San Diego, CA (US); Wei JIA, San Diego, CA (US); Jizheng XU, San Diego, CA (US); Li ZHANG, San Diego, CA (US)

(21) Appl. No.: 19/640,190

(22) Filed: Apr. 6, 2026

Related U.S. Application Data
(63) Continuation of application No. PCT/US2024/050087, filed on Oct. 4, 2024.
(60) Provisional application No. 63/588,273, filed on Oct. 5, 2023.
(60) Provisional application No. 63/574,088, filed on Apr. 3, 2024.

(51) Int. Cl. H04N 19/70; H04N 19/105; H04N 19/136; H04N 19/172; H04N 19/86

(52) U.S. Cl. CPC H04N 19/70; H04N 19/105; H04N 19/136; H04N 19/172; H04N 19/86

(57) ABSTRACT

A mechanism for processing video data is disclosed. The mechanism includes determining to obtain a list of output pictures from a processing chain, wherein the list of output pictures can include more pictures than are output by a last post-processing filter (PPF) in the processing chain. The PPFs may be neural-network post-filter (NNPFs). A conversion is performed between a visual media data and a bitstream based on the processing chain.

### CROSS-REFERENCE TO RELATED APPLICATION

This is a continuation of International Patent Application No. PCT/US2024/050087, filed on Oct. 4, 2024, which claims the priority to and benefits of U.S. Provisional Patent Application 63/588,273, filed on Oct. 5, 2023 and U.S. Provisional Patent Application 63/574,088, filed on Apr. 3, 2024. All the aforementioned patent applications are hereby incorporated by reference in their entireties.

### TECHNICAL FIELD

This patent document relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising to obtain a list of output pictures from a processing chain, wherein the list of output pictures can include more pictures than are output by a last post-processing filter (PPF) in the processing chain; and performing a conversion between a visual media data and a bitstream based on the processing chain.

A second aspect relates to a non-transitory computer-readable recording medium storing a bitstream of a video which is generated by a method performed by a video processing apparatus, wherein the method comprises: determining to obtain a list of output pictures from a processing chain, wherein the list of output pictures can include more pictures than are output by a last post-processing filter (PPF) in the processing chain; and generating a bitstream based on the determining.

A third aspect relates to a method for storing bitstream of a video comprising: determining to obtain a list of output pictures from a processing chain, wherein the list of output pictures can include more pictures than are output by a last post-processing filter (PPF) in the processing chain; generating a bitstream based on the determining; and storing the bitstream in a non-transitory computer-readable recording medium.

A fourth aspect relates to an apparatus for processing video data comprising: a processor; and a non-transitory memory with instructions thereon, wherein the instructions upon execution by the processor, cause the processor to perform any of the preceding aspects.

A fifth aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram showing an example video processing system.

FIG. 2 is a block diagram of an example video processing apparatus.

FIG. 3 is a flowchart for an example method of video processing.

FIG. 4 is a block diagram that illustrates an example video coding system.

FIG. 5 is a block diagram that illustrates an example encoder.

FIG. 6 is a block diagram that illustrates an example decoder.

FIG. 7 is a schematic diagram of an example encoder.

FIG. 8 is a flowchart for an example method of video processing.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present document for ease of understanding and do not limit the applicability of techniques and embodiments disclosed in each section only to that section. Furthermore, H.266 terminology is used in some description only for ease of understanding and not for limiting scope of the disclosed techniques. As such, the techniques described herein are applicable to other video codec protocols and designs also. In the present document, editing changes are shown to text by using “/* *\” indicating cancelled text and “{{ }}” indicating added text, with respect to the Versatile Video Coding (VVC) specification and/or the SEI messages for coded video bitstreams (VSEI) standard.

### 1. Initial Discussion

This document is related to image/video coding technologies. Specifically, this disclosure is related to the filtering process based on post-processing filter groups. The ideas may be applied individually or in various combinations, for video bitstreams coded by any codec, e.g., the VVC standard and/or the versatile SEI messages for coded video bitstreams (VSEI) standard.

### 2. Abbreviations

adaptation parameter set (APS), access unit (AU), coded layer video sequence (CLVS), coded layer video sequence start (CLVSS), cyclic redundancy check (CRC), coded video sequence (CVS), finite impulse response (FIR), intra random access point (IRAP), network abstraction layer (NAL), picture parameter set (PPS), picture unit (PU), random access skipped leading (RASL) picture, supplemental enhancement information (SEI), step-wise temporal sublayer access (STSA), video coding layer (VCL), versatile supplemental enhancement information as described in Rec. ITU-T H.274 I ISO/IEC 23002-7 (VSEI), video usability information (VUI), versatile video coding as described in Rec. ITU-T H.266| ISO/IEC 23090-3 (VVC)

### 3. Further Discussion

### 3.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) [1] standards. Since H.262, the video coding standards are based on the hybrid video coding structure wherein temporal prediction plus transform coding are utilized.

The Versatile Video Coding (VVC) standard (ITU-T H.2661 ISO/IEC 23090-3) [2] and the associated Versatile Supplemental Enhancement Information for coded video bitstreams (VSEI) standard (ITU-T H.274 ISO/IEC 23002-7) [3] are designed for use in a maximally broad range of applications, including both the simple uses such as television broadcast, video conferencing, or playback from storage media, and also more advanced use cases such as adaptive bit rate streaming, video region extraction, composition and merging of content from multiple coded video bitstreams, multiview video, scalable layered coding, and viewport-adaptive 3600 immersive media.

### 3.2 SEI Messages in General and in VVC

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.SEI I ISO/IEC 23002-7.

### 3.3 the SEI Processing Order (SPO) SEI Message

JVET-AE2027 [4] includes the specification of an SEI message named the SEI processing order (SPO) SEI message, for carrying information indicating the preferred processing order, as determined by the encoder (the content producer), for different types of SEI messages that may be present in a coded video sequence (CVS) of the bitstream.

The specification of the SPO SEI message in JVET-AE2027 is as follows.

3.3.1 General SEI payload syntax

| | Descriptor |
|---|---|
| sei_payload( payloadType, payloadSize ) { | |
| SeiExtensionBitsPresentFlag = 0 | |
| if( nal_unit_type = = PREFIX_SEI_NUT ) | |
| if( payloadType = = 0 ) | |
| ... | |
| else if( payloadType = = 213 ) | |
| sei_processing_order( payloadSize ) | |
| ... | |
| else /* nal_unit_type = = SUFFIX_SEI_NUT */ | |
| if( payloadType = = 3 ) /* Specified in Rec. | |
| ITU-T H.274 \| ISO/IEC 23002-7 */ | |
| ... | |
| if( SeiExtensionBitsPresentFlag \|\| | |
| more_data_in_payload( ) ) { | |
| if( payload_extension_present( ) ) | |
| sei_reserved_payload_extension_data | u(v) |
| sei_payload_bit_equal_to_one /* equal to 1 */ | f(1) |
| while( !byte_aligned( ) ) | |
| sei_payload_bit_equal_to_zero /* equal to 0 */ | f(1) |
| } | |
| } | |

3.3.2 SEI processing order SEI message syntax

| | Descriptor |
|---|---|
| sei_processing_order( payloadSize ) { | |
| po_num_sei_messages_minus2 | u(8) |
| for( i = 0, i < po_num_sei_messages_minus2 + 2; i++) { | |
| po_sei_wrapping_flag[ i ] | u(1) |
| po_sei_importance_flag[ i ] | u(1) |
| if( po_sei_wrapping_flag[ i ] ) { | |
| reserved_alignment_6bits | u(6) |
| sei_message( ) | |
| } else { | |
| po_sei_prefix_flag[ i ] | u(1) |
| po_sei_payload_type[ i ] | u(13) |
| if( po_sei_prefix_flag[ i ]) { | |
| po_num_prefix_bytes[ i ] | b(8) |
| for( j = 0; j < po_num_prefix_bytes[ i ]; j++ ) | |
| po_prefix_byte[ i ][ j ] | b(8) |
| } | |
| } | |
| po_sei_processing_order[ i ] | u(8) |
| } | |
| } | |

### 3.3.3 SEI Processing Order SEI Message Semantics

The SEI processing order SEI message carries information indicating the preferred processing order, as determined by the encoder (i.e., the content producer), for different types of SEI messages that may be present in a CVS.

When an SEI processing order SEI message is present in any access unit of a CVS, an SEI processing order SEI message shall be present in the first access unit of the CVS. The SEI processing order SEI message persists in decoding order from the current access unit until the end of the CVS. When there are multiple SEI processing order SEI messages present in a CVS, they shall have the same content.

It is a requirement of bitstream conformance that, within an SEI processing order SEI message, there shall be at least two pairs of the syntax elements po_sei_payload_type[i] and po_sei_processing_order[i], and there shall be at least two values of po_sei_processing_order[i] that are not equal.

The SEI processing order SEI message can carry one or more SEI prefix indications of a particular payloadType. Each SEI prefix indication is a byte string that follows the SEI payload syntax of that value of payloadType and contains a number of complete syntax elements starting from the first syntax element in the SEI payload, and may be followed by bits that do not represent any complete syntax element of the SEI payload.

These SEI prefix indications should provide sufficient information to determine the specific processing order for SEI messages having the same value of payloadType but different preferred processing order.

po_num_sei_messages_minus2 plus 2 indicates the number of SEI messages that have a processing order indicated in the SEI processing order SEI message.

po_sei_importance_flag[i] indicates the degree of importance determined by the encoder for the SEI message with index i.

If the decoding system cannot interpret or does not support any indicated SEI message that has po_sei_importance_flag[i] equal to 1, it should ignore the entire SEI processing order SEI message.
reserved_alignment_6bits has no meaning and shall be equal to 0 in bitstreams conforming to this version of this Specification. Decoders shall allow this syntax element to have other values and shall ignore the value.

If po_sei_wrapping_flag[i] is equal to 0, an SEI message should be present outside of the SEI processing order SEI message with payloadType equal to po_sei_payload_type[i]. However, if po_sei_wrapping_flag[i] is equal to 0 and no SEI message is present with payloadType equal to po_sei_payload_type[i], the following applies:
If po_sei_importance_flag[i] is equal to 1, the decoder should ignore the entire SEI processing order SEI message.
Otherwise, the decoder should ignore all data associated with the loop variable value of i.

NOTE—po_sei_wrapping_flag[i] equal to 1 enables SEI messages to be carried within the SEI processing order SEI message to prevent such SEI messages from being incorrectly interpreted by decoders that do not process the SEI processing order SEI message. Thus, po_sei_wrapping_flag[i] equal to 1 is intended to be used when po_sei_wrapping_flag[i] equal to 0 can lead to unintended results being produced by such decoders.

po_sei_prefix_flag[i] equal to 1 specifies that po_num_prefix_bytes[i] is present. po_sei_prefix_flag[i] equal to 0 specifies that po_num_prefix_bytes[i] is not present.

po_sei_payload_type[i] specifies the payloadType value of the i-th SEI message type for which preferred processing order information is provided in the SEI processing order SEI message. For any two different non-negative integer values of m and n, the values of po_sei_payload_type[m] and po_sei_payload_type[n] shall not be identical unless po_sei_prefixflag[m] and po_sei_prefixflag[n] are both equal to 1.

SeiProcessingOrderSeiList is set to consist of the payloadType values specified in clause D.2.1, except the values 137, 144, 147, 148, 179, 180, 200, 201, 208, and 213. The value of po_sei_prefix_flag[i] shall be equal to 0 when po_sei_payload_type[i] is not equal to any value among SeiProcessingOrderSeiList.

po_num_prefix_bytes[i], when present, specifies the number of bytes associated with the i-th SEI message for which preferred processing order information is provided in the SEI processing order SEI message. When not present, the value of po_num_prefix_bytes[i] is inferred to be equal to 0.

po_prefixbyte[i][j], when present, specifies thej-th byte value of the i-th SEI message.

po_sei_processing_order[i] indicates the preferred order of processing of the i-th SEI message type for which preferred processing order information is provided in the SEI processing order SEI message. For any two different integer values of m and n that are greater than or equal to 0, po_sei_processing_order[m] less than po_sei_processing_order[n] indicates any SEI message type with payloadType equal to po_sei_payload_type[m] and, when present, bytes po_prefix_byte[m][p] for p ranging from 0 to po_num_prefix_bytes[m]-1, inclusive, should be processed before any SEI message type with payloadType equal to po_sei_payload_type[n], and, when present, bytes po_prefix_byte[n][q] for q ranging from 0 to po_num_prefix_bytes[n]-1, inclusive, and po_sei_processing_order[m] equal to po_sei_processing_order[n] indicates that there is no preferred order of processing between the SEI message types. When there are multiple SEI messages with the same values of po_sei_payload_type[i], po_numprefix_bytes[i], and bytes po_prefix_byte[i][j] for j ranging from 0 to po_num_prefix_bytes[i]-1, inclusive, they shall have the same value of po_sei_processing_order[i].

po_sei_processing_order[0] shall be equal to 0, and for i greater than 0, po_sei_processing_order[i] shall be equal to po_sei_processing_order[i−1] or po_sei_processing_order[i−1]+1.

The value of po_sei_processing_order[po_num_sei_messages_minus2+1] shall not be equal to 0.

### 3.4 Signalling of Neural-Network Post-Filters

JVET-AE2006 [5] includes the specification of two SEI messages for signalling of neural-network post-filters, namely the neural-network post-filter characteristics (NNPFC) SEI message and the neural-network post-filter activation (NNPFA) SEI. JVET-AE2005 [6] includes the specification of the use of the NNPFC SEI message in VVC bitstreams.

The specification of NNPFC and NNPFA SEI messages in JVET-AE2006 and the specification of the use of the NNPFC SEI message in VVC bitstreams in JVET-AE2005 are as follows.

### 8.28 Neural-Network Post-Filter SEI Messages

### 8.28.1 General Post-Processing Filtering Process Using NNPFs

### 8.28.1.2 General

Input to this process is a bitstream BitstreamToFilter. Output of this process is a list of NNPF output pictures ListNnpfOutputPics.

First, BitstreamToFilter is decoded, and the list CroppedDecodedPictures is set to be the list of the cropped decoded pictures in output order resulted from decoding BitstreamToFilter.

Second, the filtering process for one picture, as specified in subclause 8.28.1.2, is repeatedly invoked, in output order, for each cropped decoded picture that is in CroppedDecodedPictures and for which one or more NNPFs are activated.

The order of the pictures in ListNnpfOutputPics is in output order.

Within ListNnpfOutputPics there shall be no more than one picture pertaining to any particular output time instance. When for any particular picture in CroppedDecodedPictures there are multiple NNPFs activated and only one of the NNPFs is allowed to be chosen to be applied although any of the NNPFs may be chosen, the above constraint shall apply regardless of which NNPF is chosen to be applied to the particular picture.

For any particular pair of pictures inputPicA and inputPicB consecutive in output order in CroppedDecodedPictures, when there are one or more pictures interpolatedPicSetA in ListNnpfOutputPics between inputPicA and inputPicB in output order, the pictures in interpolatedPicSetA shall be among the pictures that were output by applying a particular NNPF nnpfA with PictureRateUpsamplingFlag equal to 1 when a particular picture currPicA in CroppedDecodedPictures was the current picture. The application of any other NNPF that was used in the filtering process for one picture when currPicA was the current picture or the application of any NNPF (including nnpfA) that was used in the filtering process for one picture when any other picture currPicB in CroppedDecodedPictures was the current picture shall not output any picture between the inputPicA and inputPicB in output order.

NOTE—The intent of the constraints expressed in the above paragraph is to disallow generating NNPF output pictures between any particular pair of consecutive input pictures more than once.

### 9.28.1.2 Filtering Process for One Picture Using an NNPF

The filtering process specified in this subclause applies to each cropped decoded picture, referred to as the current picture, that is in CroppedDecodedPictures and for which one or more NNPFs are activated. When applying an NNPF to the current picture, the following applies:
The filtered and/or interpolated pictures are generated by the NNPF by applying the NNPF process specified in the semantics of the NNPFC SEI message, in a patch-wise manner, to the current picture.
The order of the pictures generated by the NNPF by applying the NNPF process being stored into the output tensor of the NNPF is in output order.

When the applied NNPF is the last NNPF that is applied to the current picture, the pictures generated by the NNPF and output by the NNPF process are included into ListNnpfOutputPics, in the same order as when the pictures are stored into the output tensor of the NNPF.

### 8.28.2 Neural-Network Post-Filter Characteristics SEI Message

### 8.28.2.1 Neural-Network Post-Filter Characteristics SEI Message Syntax

8.28.2.2 Neural-network post-filter characteristics SEI message semantics

The neural-network post-filter characteristics (NNPFC) SEI message specifies a neural network that may be used as a post-processing filter. The use of specified neural-network post-processing filters (NNPFs) for specific pictures is indicated with neural-network post-filter activation (NNPFA) SEI messages.

Use of this SEI message requires the definition of the following variables:
Input picture width and height in units of luma samples, denoted herein by CroppedWidth and CroppedHeight, respectively.
Luma sample array CroppedYPic[idx] and chroma sample arrays CroppedCbPic[idx] and CroppedCrPic[idx], when present, of the input pictures with index idx in the range of 0 to numInputPics−1, inclusive, that are used as input for the NNPF.
Bit depth BitDepthy for the luma sample array of the input pictures.
Bit depth BitDepthc for the chroma sample arrays, if any, of the input pictures.
A chroma format indicator, denoted herein by ChromaFormatIdc, as described in subclause 7.3.
When nnpfc_auxiliary_inp_ide is equal to 1, afiltering strength control value array StrengthControlVal[idx] that shall contain real numbers in the range of 0 to 1, inclusive, of the input pictures with index idx in the range of 0 to numInputPics−1, inclusive.

Input picture with index 0 corresponds to the picture for which the NNPF defined by this NNPFC SEI message is activated by an NNPFA SEI message. Input picture with index i in the range of 1 to numInputPics−1, inclusive, precedes the input picture with index i−1 in output order.

### D.12.11 Use of the Neural Network Post-Filter Characteristics SEI Message and the Neural Network Post-Filter Activation SEI Message

Let currPic be the cropped decoded output picture for which the neural-network post-processing filter (NNPF) defined by the neural-network post-filter characteristics (NNPFC) SEI message is activated by a neural-network post-filter activation (NNPFA) SEI message and currLayerId be the nuh_layer_id value of currPic.

It is a requirement of bitstream conformance that when a picture unit contains an NNPFA SEI message, the value of ph_pic_output_flag in the picture header contained in that picture unit shall be equal to 1.
NOTE—Since only cropped decoded output pictures are used as input pictures of the NNPF, the value of ph_pic_output_flag in the picture header of the coded picture corresponding to each input picture of the NNPF is equal to 1.

The variable pictureRateUpsamplingFlag is set equal to ((nnpfc_purpose & 0×08)>0)?1:0.

The variable numInputPics is set equal to nnpfc num_inputpics_minus1+1.

The variable numInferences is derived as follows:
If all of the following conditions are true, the variable numPostRoll is set equal to the value of i such that nnpfc_interpolated_pics[i] is greater than 0 and the variable numInferences is set equal to 1+numPostRoll:
   nnpfc_purpose is equal to 8 (i.e., the only purpose for the NNPF is picture rate upsampling).
   nnpfa_persistence_flag is equal to 1.
   nnpfc_interpolated_pics[i] is greater than 0 only for a single value of i that is greater than 0.
   Either of the following conditions is true:
      currPic is the last picture of the bitstream in output order that has nuh_layer_id equal to currLayerId.
      currPic is the last picture in the CLVS in output order and nnpfa_no_foll_clvs_flag is equal to 1.
Otherwise, if all of the following conditions are true, the variable numPostRoll is set equal to InpIdx[i] for the value of i such that nnpfa_output_flag[i] is equal to 1, and the variable numInferences is set equal to 1+numPostRoll:
   pictureRateUpsamplingFlag is equal to 0.
   numInputPics is greater than 1.
   nnpfa_persistence_flag is equal to 1.
   nnpfa_output_flag[idx] is equal to 1 for a single value of idx in the range of 0 to NumInpPicsInOutputTensor−1, inclusive, and for that single value of idx, InpIdx[idx] is greater than 0.
   Either of the following conditions is true:
      currPic is the last picture of the bitstream in output order that has nuh_layer_id equal to currLayerId.
      currPic is the last picture in the CLVS in output order and nnpfa_no_foll_clvs_flag is equal to 1.
   Otherwise, the variable numInferences is set equal to 1.

For each value of j in the range of 0 to numInferences −1, inclusive, the following applies:
The arrays inputPic[i] and inputPresentFlag[i] for i in the range of 0 to numInputPics−1, inclusive, representing all the input pictures and the presence of input pictures, respectively, are specified as follows:
   When j is greater than 0, for each value of k in the range of 0 to j−1, inclusive, inputPic[k] is set to be currPic and inputPresentFlag[k] is set equal to 0.
   The j-th input picture, inputPic[j], is set to be currPic and inputPresentFlag[j] is set equal to 1.
   When numInputPics is greater than 1, the following applies for each value of i in the range of j+1 to numInputPics−1, inclusive, in increasing order of i:
      If both of the following conditions are true, inputPic[i] is set to be prevPic and inputPresentFlag[i] is set equal to 1:
         Either of the following conditions is true:
         pictureRateUpsamplingFlag is equal to 1 and currPic is associated with a frame packing arrangement SEI message with frame_packing_arrangement_type equal to 5 and a particular value of fp_current_frame_is_frame0_flag, and there is a cropped decoded output picture prevPic that is the last picture in output order among all cropped decoded output pictures that have nuh_layer_id equal to currLayerId, precede inputPic[i−1] in output order, and are associated with a frame packing arrangement SEI message with frame_packing_arrangement_type equal to 5 and the same value of fp_current_frame_is_frame0 flag.
         pictureRateUpsamplingFlag is equal to 0 or currPic is not associated with a frame packing arrangement SEI message with frame_packing_arrangement_type equal to 5, and there is a cropped decoded output picture prevPic that is the last picture in output order among all cropped decoded output pictures that have nuh_layer_id equal to currLayerId and precede inputPic[i−1] in output order.
         nnpfa_no_prev_clvs_flag is equal to 0 or the coded picture corresponding to prevPic and the current picture are present in the same CLVS.
      Otherwise, the following applies:
         inputPic[i] is set to be the same picture as inputPic[i−1] and inputPresentFlag[i] is set equal to 0.
         It is a requirement of bitstream conformance that, when pictureRateUpsamplingFlag is equal to 1, nnpfc_interpolated_pics[i−1] shall be equal to 0.
         It is a requirement of bitstream conformance that when inputPresentFlag[i] is equal to 0 and nnpfc_input_pic_output_flag[i] is equal to 1, the value of nnpfa_output_flag[idx] shall be equal to 0 for the value of idx such that InpIdx[idx] is equal to i.
For purposes of interpretation of the NNPFC SEI message, the following variables are specified:
   If numInputPics is greater than 1 and there is a second NNPF that is defined by at least one NNPFC SEI message, is activated by an NNPFA SEI message for currPic, and has nnpfc_purpose equal to 4, the following applies:
      CroppedWidth is set equal to nnpfcOutputPicWidth defined for the second NNPF.
      CroppedHeight is set equal to nnpfcOutputPicHeight defined for the second NNPF.
   Otherwise, the following applies:
      CroppedWidth is set equal to the value of pps_pic_width_in_luma_samples−SubWidthC*(pps_conf_win_left_offset+pps_conf_win_right_offset) for currPic.
      CroppedHeight is set equal to the value of pps_pic_height_in_luma_samples−SubHeightC*(pps_conf_win_top_offset+pps_conf_win_bottom offset) for currPic.
   The luma sample arrays CroppedYPic[i] and the chroma sample arrays CroppedCbPic[i] and CroppedCrPic[i], when present, are derived as follows for each value of i in the range of 0 to numInputPics−1, inclusive:
      The variable sourcePic is derived as follows:
         If inputPresentFlag[i] is equal to 1 or nnpfc_absent input_pic_zero_flag is equal to 0, sourcePic is set to be inputPic[i].
         Otherwise (inputPresentFlag[i] is equal to 0 and nnpfc_absent input_pic_zero_flag is equal to 1), sourcePic is set to be a picture with a luma sample array of CroppedWidth×CroppedHeight samples equal to 0 and Cb and Cr sample arrays of (CroppedWidth/SubWidthC)×(CroppedHeight/SubHeightC) samples equal to 0.
      If numInputPics is equal to 1, the following applies:
         The luma sample array CroppedYPic[i] and the chroma sample arrays CroppedCbPic[i] and CroppedCrPic[i], when present, are set to be the 2-dimensional arrays of decoded sample values of the Y, Cb and Cr components, respectively, of sourcePic.
      Otherwise (numInputPics is greater than 1), the following applies:
         The variable sourceWidth is set equal to the value of pps_pic_width_in_luma samples−SubWidthC*(pps_conf_win_left_offset+pps_conf_win_right_offset) for sourcePic.
         The variable sourceHeight is set equal to the value of pps_pic_height_in_luma_samples−SubHeightC*(pps_conf_win_top_offset+pps_conf_win_bottom_offset) for sourcePic.
         If sourceWidth is equal to CroppedWidth and sourceHeight is equal to CroppedHeight, resampledPic is set to be the same as sourcePic.
         Otherwise (sourceWidth is not equal to CroppedWidth or sourceHeight is not equal to CroppedHeight), the following applies:
         There shall be an NNPF, hereafter referred to as the super resolution NNPF, that is defined by at least one NNPFC SEI message, is activated by an NNPFA SEI message for sourcePic, and has nnpfc_purpose equal to 4, nnpfcOutputPicWidth equal to CroppedWidth and nnpfcOutputPicHeight equal to CroppedHeight.
         resampledPic is set to be the output of the neural-network inference of the super resolution NNPF with sourcePic being an input.
         The luma sample array CroppedYPic[i] and the chroma sample arrays CroppedCbPic[i] and CroppedCrPic[i], when present, are set to be the 2-dimensional arrays of decoded sample values of the Y, Cb and Cr components, respectively, of resampledPic.
   BitDepthy and BitDepthc are both set equal to BitDepth.
   ChromaFormatldc is set equal to sps_chroma_format_idc.
   The array StrengthControlVal[i] for all values of i in the range of 0 to numInputPics−1, inclusive, specifying the filtering strength control value for the input pictures for the NNPF, is derived as follows:
      StrengthControlVal[i] is set equal to the value of (firstSliceQpy+QpBdOffset)+(63+QpBdOffset), where firstSliceQpy is equal to SliceQpy of the first slice of inputPic[i].
         There shall not be more than two NNPFC SEI messages present in a picture unit with the same value of nnpfc_id. When there are two NNPFC SEI messages present in a picture unit with the same value of nnpfc_id, these SEI messages shall have different content. When two NNPFC SEI messages with the same nnpfc_id and different content are present in the same picture unit, both of these NNPFC SEI messages shall be in the same SEI NAL unit.

### 4. Technical Problems Solved by Disclosed Technical Solutions

An example design for post-processing filters using SEI messages has the following problems:

First, there is only a general post-processing filtering process using NNPFs specified, while there are also PPFs that are not NNPFs.

Second, there lacks a post-processing filtering process for cascaded NNPFs other than the special PPF cascading case. The special PPF cascading case is when such two PPFs are both activated for a current picture: the two PPFs are both NNPFs, one of the two NNPFs has nnpfc_purpose equal to 4 and the other has multiple input pictures, and neither of the two NNPFs is associated with an SEI processing order SEI message.

Third, the list of output pictures from the post-processing filtering process cannot include cropped decoded pictures that do not have corresponding output pictures that are output by any applied PPF or PPF output pictures that are output by an PPF that is not the last PPF applied when a particular picture is the current picture.

### 5. A Listing of Solutions and Embodiments

To solve the above-described problems, methods as summarized below are disclosed. The aspects should be considered as examples to explain the general concepts and should not be interpreted in a narrow way. Furthermore, these examples can be applied individually or combined in any manner.
1) To solve the first problem, one of more of the following methods are specified:
   a. In one example, a general post-processing filtering process using post-processing filters (PPFs), including but not limited to NNPFs, is specified.
b. In one example, PPFs are grouped, PPFs groups are alternative to each other such that only one PPF group may be chosen to be applied for any particular picture.
   c. In one example, PPFs within the chosen PPF group are applied in the cascading manner such that the output of one PPF is used as the input of the PPF to be applied next.
   d. In one example, indications of which PPFs are grouped may be signalled or implicitly derived.
      i. In one example, group information of the activate PPFs may be signalled, such as in an order for processing PPFs.
      ii. In one example, an implicit group is defined as the case that when such two PPFs are both activated for a picture: the two PPFs are both NNPFs (i.e., the payloadType value for the NNPFs indicates the neural-network post-filter characteristics SEI message), one of the two NNPFs has nnpfc_purpose equal to 4 and the other has multiple input pictures, and neither of the two NNPFs is associated with an SEI processing order SEI message. In this case, the two NNPFs are implicitly considered as belonging to one PPF group.
2) To solve the second problem, one of more of the following methods are specified:
   a. In one example, regardless of how many PPFs in the chosen PPF group are to be applied for a current picture, and regardless of what types of PPFs are those, it is allowed for output pictures by an earlier applied PPF to be used as input pictures by a later applied PPF.
   b. In one example, a list CandInputPicList that includes all candidates for input pictures is initialized or reset to contain the list of the cropped decoded pictures in output order resulted from decoding BitstreamToFilter for each current picture before applying the first PPF for the current picture, and is updated each time when a PPF is applied, possibly except for the PPF that is last applied for the current picture.
      i. In one example, after an PPF is applied for the current picture, the list CandInputPicList is updated by replacing each of those pictures in the list having a corresponding PPF output picture of the PPF with the corresponding PPF output picture.
         1. Alternatively, in one example, before an PPF is applied for the current picture, the list CandInputPicList is updated by replacing each of those pictures in the list having a corresponding PPF output picture of the PPF and before the current picture in output order with the corresponding PPF output picture.
      ii. In one example, after an PPF is applied for the current picture, the list CandInputPicList is updated by inserting those interpolated pictures, if any, into the list and placing them such that all pictures in the updated list are in output order.
      iii. In one example, after an PPF is applied for the current picture, the list CandInputPicList is updated by both replacing each of those pictures in the list having a corresponding PPF output picture of the PPF with the corresponding PPF output picture, and inserting those interpolated pictures, if any, into the list and placing them such that all pictures in the updated list are in output order.
      iv. In one example, when a picture in the list CandInputPicList is replaced, the properties of the picture, including at least one or more of the following, e.g., as part of the list, are also updated:
         1. The picture width in units of luma samples
         2. The picture height in units of luma samples
         3. The bit depth for the luma sample array of the picture
         4. The bit depth for the chroma sample arrays, if any, of the picture
         5. The chroma format indicator of the picture
      v. In one example, when a picture is inserted into the list CandInputPicList, the properties of the picture, including at least one or more of the following, are also stored, e.g., as part of the list:
         1. The picture width in units of luma samples
         2. The picture height in units of luma samples
         3. The bit depth for the luma sample array of the picture
         4. The bit depth for the chroma sample arrays, if any, of the picture
         5. The chroma format indicator of the picture
3) To solve the third problem, one of more of the following methods are specified:
   a. In one example, it is specified that the output of the general post-processing filtering process is a list of output pictures ListOutputPics that can include more pictures that are output by the last applied PPF.
      i. In one example, the list ListOutputPics can include cropped decoded pictures that do not have corresponding output pictures that are output by any applied PPF.
      ii. In one example, the list ListOutputPics can include PPF output pictures that are output by an PPF that is not the last PPF applied when a particular picture is the current picture.
      iii. In one example, the list ListOutputPics is initialized, before the application of any PPF, to contain the list of the cropped decoded pictures in output order resulted from decoding BitstreamToFilter, and is updated each time when a PPF is applied.
         1. In one example, after an PPF is applied, the list ListOutputPics is updated by replacing each of those pictures in the list having a corresponding PPF output picture of the PPF with the corresponding PPF output picture.
         2. In one example, after an PPF is applied, the list ListOutputPics is updated by inserting those interpolated pictures, if any, into the list and placing them such that all pictures in the updated list are in output order.
         3. In one example, after an PPF is applied, the list ListOutputPics is updated by both replacing each of those pictures in the list having a corresponding PPF output picture of the PPF with the corresponding PPF output picture, and inserting those interpolated pictures, if any, into the list and placing them such that all pictures in the updated list are in output order.
      iv. In one example, when a picture in the list ListOutputPics is replaced, the properties of the picture, including at least one or more of the following, e.g., as part of the list, are also updated:
         1. The picture width in units of luma samples
         2. The picture height in units of luma samples
         3. The bit depth for the luma sample array of the picture
         4. The bit depth for the chroma sample arrays, if any, of the picture
         5. The chroma format indicator of the picture
      v. In one example, when a picture is inserted into the list ListOutputPics, the properties of the picture, including at least one or more of the following, are also stored, e.g., as part of the list:
         1. The picture width in units of luma samples
         2. The picture height in units of luma samples
         3. The bit depth for the luma sample array of the picture
         4. The bit depth for the chroma sample arrays, if any, of the picture
         5. The chroma format indicator of the picture
4) In one example, based on any one or more of the above items, a PPF group is also referred to as a PPF processing chain or simply as a processing chain.
5) In one example, based on any one or more of the above items, a PPF may be indicated by an SEI message that indicates a post-processing operation and for which the payloadType value is included in the list SeiProcessingOrderSeiList, which is specified in the semantics of the SEI processing order (SPO) SEI message.
6) In one example, based on any one or more of the above items, it is specified that, after the PPF is applied, the lists CandInputPicList and ListOutputPics are both updated, in the same manner, by 1) replacing each of those pictures in the list having a corresponding PPF output picture of the PPF with the corresponding PPF output picture, and 2) inserting those interpolated or extrapolated pictures, if any, into the list and placing them such that all pictures in the updated list are in output order.

### 6. Embodiments

Below are some example embodiments for the aspects summarized above in Section 5.

Most relevant parts that have been added or modified are in “{{ }}”, and some of the deleted parts are in “/* *\”. There may be some other changes that are editorial in nature and thus not indicated. The changes are based on JVET-AE2005, JVET-AE2006, and JVET-AE2027.

### 6.1 Embodiment 1

This embodiment is for the following items summarized above in Section 5: La, 1b, 1c, 2.a, 2.b, 2.b.iii, 3.a, 3.a.i, 3.a.ii, 3.a.iii, 3.a.iii.3.

8.28.1 General post-processing filtering process 1*using NNPFs*\{{using PPFs}}

### 8.28.1.1 General

Input to this process is a bitstream BitstreamToFilter. Output of this process is /*a list of NNPF output pictures ListNnpfOutputPics*\{{a list of output pictures ListOutputPics}}.

First, BitstreamToFilter is decoded, the list CroppedDecodedPictures is set to be the list of the cropped decoded pictures in output order resulted from decoding BitstreamToFilter {{, and the list ListOutputPics is initialized to be the same as CroppedDecodedPictures}}.

Second, the filtering process for one picture, as specified in subclause 8.28.1.2, is repeatedly invoked, in output order, for each cropped decoded picture that is in CroppedDecodedPictures and for which one or more /*NNPFs*

{{PPFs of one or more PPF groups}} are activated {{and only one of the groups is chosen to be applied.
For each current picture, there can be multiple PPFs activated and belonging to one or more PPF groups.
PPF groups are alternative to each other, i.e., at most one group can be chosen to be applied. Except for the
special PPF cascading case, each PPF group containing multiple PPFs is associated with an SEI processing
order SEI message with a particular value of po_id. The special PPF cascading case is when such two PPFs
are both activated for a current picture: the two PPFs are both NNPFs, one of the two NNPFs has
nnpfc_purpose equal to 4 and the other has multiple input pictures, and neither of the two NNPFs is
associated with an SEI processing order SEI message. In this case, the two NNPFs are implicitly considered
as belonging to one PPF group. Except for the special PPF cascading case, any PPF not associated with an
SEI processing order SEI message is in its own PPF group. One or more PPFs in the chosen PPF group can
be applied. When multiple PPFs (in the chosen PPF group) are applied, they are applied in the cascading
manner, meaning that they are applied in the order indicated by the SEI processing order SEI message
associated with the chosen PPF group, and for each applied PPF that is not the last applied PPF, the output
is used as the input of the next applied PPF. }}

The order of the pictures in /*ListNnpfOutputPics*\{{ListOutputPics}} is in output order.

Within /*ListNnpfOutputPics*\{{ListOutputPics}} there shall be no more than one picture pertaining to any particular output time instance. When for any particular picture in CroppedDecodedPictures there are /*multiple NNPFs*\-{{PPFs of multiple PPF groups}} activated /* and only one of the NNPFs is allowed to be chosen to be applied although any of the NNPFs may be chosen*\, the above constraint shall apply regardless of /*which NNPF is chosen to be applied to the particular picture*\-{ }{which group of PPFs is chosen to be applied when the particular picture is the current picture}}.

For any particular pair of pictures inputPicA and inputPicB consecutive in output order in CroppedDecodedPictures, when there are one or more pictures interpolatedPicSetA in /*ListNnpfOutputPics*\{{ListOutputPics}} between inputPicA and inputPicB in output order, the pictures in interpolatedPicSetA shall be among the pictures that were output by applying aparticular /*NNPFnnpfA with PictureRateUpsamplingFlag equalto 1*\{{PPF ppfA}} when aparticular picture currPicA in CroppedDecodedPictures was the current picture. The application of any other /*NNPF*\{{PPF}} that was used in the filtering process for one picture when currPicA was the current picture or the application of any /*NNPF (including nnpfA)*\{{PPF (including ppfA)}} that was used in the filtering process for one picture when any other picture currPicB in CroppedDecodedPictures was the current picture shall not output any picture between the inputPicA and inputPicB in output order.

NOTE—The intent of the constraints expressed in the above paragraph is to disallow generating /*NNPF*\{{PPF}}output pictures between any particular pair of consecutive input pictures more than once.

{{8.28.1.2 Filtering process for one picture
The filtering process specified in this subclause applies to each cropped decoded picture, referred to as the
current picture, that is in CroppedDecodedPictures and for which one or more groups of PPFs are activated,
only one of the PPF groups is chosen to be applied, and the number of PPFs (in the chosen PPF group) to be
applied is greater than 0.
The filtering process for one picture using one PPF, as specified in subclause 8.28.1.3, is repeatedly invoked
for each of the PPFs to be applied. When the number of PPFs to be applied is greater than 1, the following
applies:

| | |
|---|---|
| - | If the special PPF cascading case applies for the chosen PPF group, the NNPF with nnpfc_purpose equal |
| | to 4 is applied first, followed by the NNPF with multiple input pictures. |
| - | Otherwise (the special PPF cascading case does not apply for the chosen PPF group), the PPFs are |
| | applied in the preferred order indicated by the SEI processing order SEI message associated with the |
| | chosen group of PPFs. }} |

/*8.28.1.2 Filtering process for one picture using an NNPF*\
{{8.28.1.3 Filtering process for one picture using one PPF}}

The filtering process specified in this subclause /*applies to each cropped decoded picture, referred to as the current picture, that is in CroppedDecodedPictures and for which one or more NNPFs are activated*\{{when a particular PPF is applied when a particular picture is the current picture.

Before the PPF is applied, when the PPF is the first PPF to be applied, the list CandInputPicList is set to be identical to CroppedDecodedPictures.

When applying a PPF to the current picture, the input pictures for the PPF are selected from the list CandInputPicList, and the order of the pictures generated and output by the PPF are in output order. }}

When applying {{a PPF that is}} an NNPF to the current picture, the following applies:
The filtered and/or interpolated pictures are generated by the NNPF by applying the NNPF process specified in the semantics of the NNPFC SEI message, in a patch-wise manner, to the current picture.
The order of the pictures generated by the NNPF by applying the NNPF process being stored into the output tensor of the NNPF is in output order.

/*When the applied NNPF is the last NNPF that is applied to the current picture, the pictures generated by the
NNPF and output by the NNPF process are included into ListNnpfOutputPics, in the same order as when the
pictures are stored into the output tensor of the NNPF. *\
{{After the PPF is applied, the lists CandInputPicList and ListOutputPics are both updated, in the same
manner, by 1) replacing each of those pictures in the list having a corresponding PPF output picture of the
PPF with the corresponding PPF output picture, and 2) inserting those interpolated pictures, if any, into the
list and placing them such that all pictures in the updated list are in output order. }}

### 8.28.2.2 Neural-Network Post-Filter Characteristics SEI Message Semantics

The neural-network post-filter characteristics (NNPFC) SEI message specifies a neural network that may be used as a post-processing filter. The use of specified neural-network post-processing filters (NNPFs) for specific pictures is indicated with neural-network post-filter activation (NNPFA) SEI messages.

Use of this SEI message requires the definition of the following variables:

| | |
|---|---|
| {{- | The list CandInputPicList that contains a list of pictures in output |
| | order from which the input pictures for the NNPF are selected. |
| | NOTE 1 - This list is updated by the PPF filtering process each |
| | time when a PPF is applied for the current picture unless the PPF |
| | is the last PPF that is applied for the current picture. }} |

Input picture width and height in units of luma samples, denoted herein by CroppedWidth and CroppedHeight, respectively.
Luma sample array CroppedYPic[idx] and chroma sample arrays CroppedCbPic[idx] and CroppedCrPic[idx], when present, of the input pictures with index idx in the range of 0 to numInputPics−1, inclusive, that are used as input for the NNPF.
Bit depth BitDepthy for the luma sample array of the input pictures.
Bit depth BitDepthc for the chroma sample arrays, if any, of the input pictures.

| | |
|---|---|
| /*- | A chroma format indicator, denoted herein by ChromaFormatIdc, as |
| | described in subclause 7.3. *\ |
| {{- | Chroma format indicator ChromaFormatIdc, as described in |
| | subclause 7.3, of the input pictures. }} |

When nnpfc_auxiliary_inp_ide is equal to 1, afiltering strength control value array StrengthControlVal[idx] that shall contain real numbers in the range of 0 to 1, inclusive, of the input pictures with index idx in the range of 0 to numInputPics−1, inclusive.

Input picture with index 0/*corresponds*\{{is the picture in CandInputPicList corresponding}} to the picture for which the NNPF defined by this NNPFC SEI message is activated by an NNPFA SEI message. Input picture with index i in the range of 1 to numInputPics−1, inclusive, precedes the input picture with index i−1 in output order.

{{NOTE 2 - The picture in CandInputPicList corresponding to a picture is
either the cropped decoded output picture of that picture or a filtered
version of the cropped decoded output picture that was an output picture
of a previously applied PPF. }}

The variables SubWidthC and SubHeightC are derived from ChromaFormatIdc as specified by Table 2. nnpfc_absent input_pic_zero_flag equal to 1 indicates that the NNPF expects an input picture {{corresponding to a picture}} that is not present in the bitstream to be represented by sample arrays with sample values equal to 0. nnpfc_absent_input_pic_zero flag equal to 0 indicates that the NNPF expects an input picture inputPicA {{corresponding to a picture}} that is not present in the bitstream to be represented by the input picture inputPicB that is the closest to inputPicA in output order and {{the picture corresponding to inputPicB}} is present in the bitstream.

nnpfano_prevclvsflag equal to 1 specifies that {{th pictures corresponding to}} the input pictures for the NNPF do not originate from a previous CLVS. nnpfa_no_prev_clvs_flag equal to 0 specifies that {{the pictures corresponding to}} the input pictures for the NNPF may or may not originate from a previous CLVS.

NOTE 4—The value of nnpfa_no_prev_clvs_flag can be changed from 0 to 1, when the current CLVS is spliced from another bitstream next to the previous CLVS and this NNPFA SEu message would cause one or more input pictures to be selected {{that have corresponding pictures}} from one or more previous CLVSs and therefore is likely to impact the output of the target NNPF negatively. nnpfa_no_follclvs_flag equal to 1 specifies that when this NNPFA SE messagepersists for the last PU of a CLVS in output order, the NNPFA SEI message is treated like it persisted for the last PU, in output order, of the current layer within the bitstream. When this NNPFA SEI message does not persist for the last PU, in output order, of a CLVS in output order or nnpfano_foll_clvs_flag is equal to 0, the value of nnpfa_no_foll_clvs_flag causes no specific impact.

NOTE 5—The value of nnpfafno(foll_clvs_flag can be changed from 0 to 1 for a picture-rate-upsampling NNPF, when the following CLVS is spliced from a different bitstream next to the current CLVS. Consequently, the NNPF process interpolates pictures up to the end of the current CLVS using input pictures {{corresponding to pictures}} originating from the current CLVS only.

. . .
D.11 SEI processing order SEI message
D.11.1 SEI processing order SEI message syntax

| | Descriptor |
|---|---|
| sei_processing_order( payloadSize ) { | |
| po_id | ue(v) |
| po_num_sei_messages_minus2 | u(8) |
| for( i = 0, i < | |
| po_num_sei_messages_minus2 + 2; i++) { | |
| po_sei_wrapping_flag[ i ] | u(1) |
| po_sei_importance_flag[ i ] | u(1) |
| if( po_sei_wrapping_flag[ i ] ) { | |
| while( !byte_aligned( ) ) | |
| po_alignment_zero_bit | f(1) |
| sei_message( ) | |
| } else { | |
| po_sei_prefix_flag[ i ] | u(1) |
| po_sei_payload_type[ i ] | u(13) |
| if( po_sei_prefix_flag[ i ]) { | |
| po_num_prefix_bytes_minus1[ i ] | b(8) |
| for( j = 0; j <= | |
| po_num_prefix_bytes_minus1[ i ]; j++ ) | |
| po_prefix_byte[ i ][ j ] | b(8) |
| } | |
| } | |
| po_sei_processing_order[ i ] | u(8) |
| } | |
| } | |

### D.11.2 EI Processing Order EI Message Semantics

The SEI processing order SEI message carries information indicating the preferred processing order, as determined by the encoder (i.e., the content producer), for a group of different types of SEI messages that may be present in a CVS and that may be applied in a cascading manner.

NOTE 1—In the semantics of this SEI message, two different types of SEI messages may have the same SEI payloadType value but are differentiated by some syntax elements in the SEI payload. For example, two neural-network post-filter characteristics (NNPFC) SEI messages with different nnpfc_id values are considered as two different types of SEI messages.

When an SEI processing order SEI message with a particular value of po_id is present in any access unit of a CVS, an SEI processing order SEI message with the particular value of po_id shall be present in the first access unit of the CVS. The SEI processing order SEI message persists in decoding order from the current access unit until the end of the CVS. When there are multiple SEI processing order SEI messages with the same value of po_id present in a CVS, they shall have the same content.

It is a requirement of bitstream conformance that, within an SEI processing order SEI message, there shall be at least two pairs of the syntax elements po_sei_payload_type[i] and po_sei_processing_order[i], and there shall be at least two values of po_sei_processing_order[i] that are not equal.

The SEI processing order SEI message can carry one or more SEI prefix indications of a particular payloadType. Each SEI prefix indication is a byte string that follows the SEI payload syntax of that value of payloadType and contains a number of complete syntax elements starting from the first syntax element in the SEI payload, and may be followed by bits that do not represent any complete syntax element of the SEI payload.

These SEI prefix indications should provide sufficient information to determine the specific processing order for SEI messages having the same value of payloadType but different preferred processing order. po_id contains an identifying number that identifies a group of SEI message types for which the preferred order of processing is indicated in the SEI processing order SEI message. The value of po_id shall be in the range of 0 to 2³²-2, inclusive. Values of po_id from 256 to 511, inclusive, and from 23³¹ to 2³²-2, inclusive, are reserved for future use by ITU-T ISO/IEC. Decoders conforming to this edition of this document encountering an SEI processing order SEI message with po_id in the range of 256 to 511, inclusive, or in the range of 2³¹ to 2³²-2, inclusive, shall ignore the SEI message.

A post-processing filter (PPF) may be indicated by an SEI message for which the payloadType value is in SeiProcessingOrderSeiList, specified below.

For each picture, there can be multiple PPFs activated and belonging to one or more PPF groups. PPF groups are alternative to each other, i.e., at most one group can be chosen to be applied.

A special PPF cascading case is defined as the case when such two PPFs are both activated for a picture: the two PPFs are both NNPFs (i.e., the payloadType value for the NNPFs indicates the neural-network post-filter characteristics SEI message), one of the two NNPFs has nnpfc_purpose equal to 4 and the other has multiple input pictures, and neither of the two NNPFs is associated with an SEI processing order SEI message. In this case, the two NNPFs are implicitly considered as belonging to one PPF group, and the NNPF with nnpfc_purpose equal to 4 is applied first.

Except for the special PPF cascading case, each PPF group containing multiple PPFs is associated with an SEI processing order SEI message with a particular value of po_id. Except for the special PPF cascading case, any PPF not associated with an SEI processing order SEI message is in its own PPF group.

One or more PPFs in the chosen PPF group can be applied. When multiple PPFs (in the chosen PPF group) are applied, they are applied in the cascading manner, meaning that they are applied in the order indicated by the SEI processing order SEI message associated with the chosen PPF group, and for each applied PPF that is not the last applied PPF, the output is used as the input of the next applied PPF.
po_num_sei_messages_minus2 plus 2 indicates the number of SEI messages that have aprocessing order indicated in the SEI processing order SEI message.
po_sei_importance_flag[i] indicates the degree of importance determined by the encoder for the SEI message with index i.

If the decoding system cannot interpret or does not support any indicated SEI message that has po_sei_importance_flag[i] equal to 1, it should ignore the entire SEI processing order SEI message.

po_alignment_zero_bit shall be equal to 0.

If po_sei_wrapping_flag[i] is equal to 0, an SEI message should be present outside of the SEI processing order SEI message with payloadType equal to po_sei_payload_type[i]. However, if po_sei_wrapping_flag[i] is equal to 0 and no SEI message is present with payloadType equal to po_sei_payload_type[i], the following applies:
If po_sei_importance_flag[i] is equal to 1, the decoder should ignore the entire SEI processing order SEI message.
Otherwise, the decoder should ignore all data associated with the loop variable value of i.

NOTE 2—po_sei_wrapping_flag[i] equal to 1 enables SEI messages to be carried within the SEI processing order SEI message to prevent such SEI messages from being incorrectly interpreted by decoders that do not process the SEI processing order SEI message. Thus, po_sei_wrapping_flag[i] equal to 1 is intended to be used when po_sei_wrapping_flag[i] equal to 0 can lead to unintended results being produced by such decoders.

po_sei_prefix_flag[i] equal to 1 specifies that po_num_prefx_bytes[i] is present. po_sei_prefix_flag[i] equal to 0 specifies that po_num_prefix_bytes[i] is not present.

po_sei_payload_type[i] specifies the payloadType value of the i-th SEI message type for which preferred processing order information is provided in the SEI processing order SEI message. For any two different non-negative integer values of m and n, the values of po_sei_payload_type[m] and po_sei_payload_type[n] shall not be identical unless po_sei_prefix_flag[m] and po_sei_prefix_flag[n] are both equal to 1.

SeiProcessingOrderSeiList is set to consist of the payloadType values specified in clause D.2.1, except the values 137, 144, 147, 148, 179, 180, 200, 201, 208, and 213. The value of po_sei_prefix_flag[i] shall be equal to 0 when po_sei_payload_type[i] is not equal to any value among SeiProcessingOrderSeiList.

When present, po_num_prefix_bytes_minus1[i] plus 1 specifies the number of bytes associated with the i-th SEI message for which preferred processing order information is provided in the SEI processing order SEI message. po_prefixbyte[i][j], when present, specifies the j-th byte value of the i-th SEI message.

po_sei_processing_order[i] indicates the preferred order of processing of the i-th SEI message type for which preferred processing order information is provided in the SEI processing order SEI message. For any two different integer values of m and n that are greater than or equal to 0, po_sei_processing_order[m] less than po_sei_processing_order[n] indicates any SEI message type with payloadType equal to po_sei_payload_type[m] and, when present, bytes po_prefix_byte[m][p] for p ranging from 0 to po_num_prefix_bytes[m]-1, inclusive, should be processed before any SEI message type with payloadType equal to po_sei_payload_type[n], and, when present, bytes po_prefix_byte[n][q] for q ranging from 0 to po_num_prefix_bytes[n]-1, inclusive, and po_sei_processing_order[m] equal to po_sei_processing_order[n] indicates that there is no preferred order of processing between the SEI message types. When there are multiple SEI messages with the same values of po_sei_payload_type[i], po_num_prefix_bytes[i], and bytes po_prefix_byte[i][j] for j ranging from 0 to po_num_prefix_bytes[i]-1, inclusive, they shall have the same value of po_sei_processing_order[i]. po_sei_processing_order[0] shall be equal to 0, and for i greater than 0, po_sei_processing_order[i] shall be equal to po_sei_processing_order[i−1] or po_sei_processing_order[i−1]+1.

The value of po_sei_processing_order[po_num_sei_messages_minus2+1] shall not be equal to 0.

### D.12.11 Use of {{the Post-Processing Filter SEI Messages, Including}} the Neural Network Post-Filter Characteristics SEI Message and the Neural Network Post-Filter Activation SEI Message

{{A post-processing filter (PPF) may be indicated by an SEI message for
which the payloadType value is in SeiProcessingOrderSeiList, which is
specified in the semantics of the SEI processing order SEI message. }}

Let currPic be the cropped decoded output picture for which the {{post-processing filter (PPF), e.g., }}neural-network post-processing filter (NNPF) defined by the neural-network post-filter characteristics (NNPFC) SEI message{{, }} is activated{{, e.g., }} by a neural-network post-filter activation (NNPFA) SEI message, and currLayerId be the nuh_layer_id value of currPic.

```
{{The list candInputPicList contains a list of pictures in output order from which the input pictures for the
PPF are selected.
  NOTE 1 - This list is updated by the PPF filtering process each time when a PPF is applied for the
  current picture unless the PPF is the last PPF that is applied for the current picture.
When the PPF is not an NNPF, the PPF is considered to have only one input picture that is the picture in
candInputPicList corresponding to the current picture.
  NOTE 2 - The picture in candInputPicList corresponding to a cropped decoded output picture is either
  the cropped decoded output picture itself or a filtered version of the cropped decoded output picture that
  was an output picture of a previously applied PPF.
If the PPF is the first PPF that is applied for the current picture, the following applies:
```

| | |
|---|---|
| - | CroppedWidth is set equal to the value of pps_pic_width_in_luma_samples − SubWidthC * |
| | ( pps_conf_win_left_offset + pps_conf_win_right_offset ) for currPic. |
| - | CroppedHeight is set equal to the value of pps_pic_height_in_luma_samples − SubHeightC * |
| | ( pps_conf_win_top_offset + pps_conf_win_bottom_offset ) for currPic. |
| - | BitDepth_{Y} and BitDepth_{C} are both set equal to BitDepth. |
| - | ChromaFormatIdc is set equal to sps_chroma_format_idc. |

Otherwise (the PPF is not the first PPF that is applied for the current picture), the following applies:

| | |
|---|---|
| - | CroppedWidth is set equal to the picture width in units of luma samples of the picture in |
| | candInputPicList corresponding to the current picture. |
| - | CroppedHeight is set equal to the picture height in units of luma samples of the picture in |
| | candInputPicList corresponding to the current picture. |
| - | BitDepth_{Y} is set equal to the bit depth BitDepth_{Y} for the luma sample array of the picture in |
| | candInputPicList corresponding to the current picture. |
| - | BitDepth_{C} is set equal to the bit depth BitDepth_{C} for the chroma sample arrays, if any, of the picture |
| | in candInputPicList corresponding to the current picture. |
| - | ChromaFormatIdc is set equal to the chroma format indicator ChromaFormatIdc of the the |
| | picture in candInputPicList corresponding to the current picture. |

The remainder of this subclause applies when the PPF is an NNPF. }}

It is a requirement of bitstream conformance that when a picture unit contains an NNPFA SEI message, the value of ph_pic_output_flag in the picture header contained in that picture unit shall be equal to 1.

NOTE 3—Since {{when the NNPF is the first PPF that is applied for currPic}} only cropped decoded output pictures are used as input pictures of the NNPF, the value of ph_pic_output_flag in the picture header of the coded picture corresponding to each input picture of the NNPF is equal to 1.

The variable pictureRateUpsamplingFlag is set equal to ((nnpfc_purpose & 0×08)>0)?1:0.

The variable numInputPics is set equal to nnpfc num_inputpics_minus1+1.

The variable numInferences is derived as follows:
If all of the following conditions are true, the variable numPostRoll is set equal to the value of i such that nnpfc_interpolated_pics[i] is greater than 0 and the variable numInferences is set equal to 1+numPostRoll:
   nnpfc_purpose is equal to 8 (i.e., the only purpose for the NNPF is picture rate upsampling).
   nnpfa_persistence_flag is equal to 1.
   nnpfc_interpolated_pics[i] is greater than 0 only for a single value of i that is greater than 0.
   Either of the following conditions is true:
      currPic is the last picture of the bitstream in output order that has nuh_layer_id equal to currLayerId.
      currPic is the last picture in the CLVS in output order and nnpfa_no_foll_clvs_flag is equal to 1.
Otherwise, if all of the following conditions are true, the variable numPostRoll is set equal to InpIdx[i] for the value of i such that nnpfa_output_flag[i] is equal to 1, and the variable numInferences is set equal to 1+numPostRoll:
   pictureRateUpsamplingFlag is equal to 0.
   numInputPics is greater than 1.
   nnpfa_persistence_flag is equal to 1.
   nnpfa_output_flag[idx] is equal to 1 for a single value of idx in the range of 0 to NumInpPicsInOutputTensor −1, inclusive, and for that single value of idx, InpIdx[idx] is greater than 0.
   Either of the following conditions is true:
      currPic is the last picture of the bitstream in output order that has nuh_layer_id equal to currLayerId.
      currPic is the last picture in the CLVS in output order and nnpfa_no_foll_clvs_flag is equal to 1.
Otherwise, the variable numInferences is set equal to 1.

For each value of j in the range of 0 to numInferences −1, inclusive, the following applies {{for the derivation of the input pictures for the NNPF such that each input picture is a picture in candInputPicList: }}
The arrays inputPic[i] and inputPresentFlag[i] for i in the range of 0 to numInputPics−1, inclusive, representing all the input pictures and the presence of input pictures, respectively, are specified as follows:
   When j is greater than 0, for each value of k in the range of 0 to j−1, inclusive, inputPic[k] is set to be {{the picture in candInputPicList corresponding to}}currPic and inputPresentFlag[k] is set equal to 0.
   The j-th input picture, inputPic[j], is set to be {{the picture in candInputPicList corresponding to}}currPic and inputPresentFlag[j] is set equal to 1.
   When numInputPics is greater than 1, the following applies for each value of i in the range of j+1 to numInputPics−1, inclusive, in increasing order of i:
      If both of the following conditions are true, inputPic[i] is set to {{be the picture in candInputPicList corresponding to}}prevPic and inputPresentFlag[i] is set equal to 1:
         Either of the following conditions is true:
         pictureRateUpsamplingFlag is equal to 1 and currPic is associated with a frame packing arrangement SEI message with frame_packing_arrangement_type equal to 5 and a particular value of fp_current_frame_is_frame0_flag, and there is a cropped decoded output picture prevPic that is the last picture in output order among all cropped decoded output pictures that have nuh_layer_id equal to currLayerId, precede inputPic[i−1] in output order, and are associated with a frame packing arrangement SEI message with frame_packing_arrangement_type equal to 5 and the same value of fp_current_frame_is_frame0 flag.
         pictureRateUpsamplingFlag is equal to 0 or currPic is not associated with a frame packing arrangement SEI message with frame_packing_arrangement_type equal to 5, and there is a cropped decoded output picture prevPic that is the last picture in output order among all cropped decoded output pictures that have nuh_layer_id equal to currLayerId and precede inputPic[i−1] in output order.
         nnpfa_no_prev_clvs_flag is equal to 0 or the coded picture corresponding to prevPic and the current picture are present in the same CLVS.
      Otherwise, the following applies:
         inputPic[i] is set to be the same picture as inputPic[i−1] and inputPresentFlag[i] is set equal to 0.
         It is a requirement of bitstream conformance that, when pictureRateUpsamplingFlag is equal to 1, nnpfc_interpolated_pics[i−1] shall be equal to 0.
         It is a requirement of bitstream conformance that when inputPresentFlag[i] is equal to 0 and nnpfc_input_pic_output_flag[i] is equal to 1, the value of nnpfa_output_flag[idx] shall be equal to 0 for the value of idx such that InpIdx[idx] is equal to i.
For purposes of interpretation of the NNPFC SEI message, the following variables are specified:

| /*- | If numInputPics is greater than 1 and there is a second NNPF that is defined by at least one NNPFC | |
|---|---|---|
| | SEI message, is activated by an NNPFA SEI message for currPic, and has nnpfc_purpose equal to 4, | |
| | the following applies: | |
| | - | CroppedWidth is set equal to nnpfcOutputPicWidth defined for the second NNPF. |
| | - | CroppedHeight is set equal to nnpfcOutputPicHeight defined for the second NNPF. |
| - | Otherwise, the following applies: | |
| | - | CroppedWidth is set equal to the value of pps_pic_width_in_luma_samples − SubWidthC * |
| | | ( pps_conf_win_left_offset + pps_conf_win_right_offset ) for currPic. |
| | - | CroppedHeight is set equal to the value of pps_pic_height_in_luma_samples − SubHeightC * |
| | | ( pps_conf_win_top_offset + pps_conf_win_bottom_offset ) for currPic. *\ |

The luma sample arrays CroppedYPic[i] and the chroma sample arrays CroppedCbPic[i] and CroppedCrPic[i], when present, are derived as follows for each value of i in the range of 0 to numInputPics−1, inclusive:
The variable sourcePic is derived as follows:
   If inputPresentFlag[i] is equal to 1 or nnpfc_absent input_pic_zero_flag is equal to 0, sourcePic is set to be inputPic[i].
   Otherwise (inputPresentFlag[i] is equal to 0 and nnpfc_absent input_pic_zero_flag is equal to 1), sourcePic is set to be apicture with a luma sample array of CroppedWidth×CroppedHeight samples equal to 0 and Cb and Cr sample arrays of (CroppedWidth/SubWidthC)×(CroppedHeight/SubHeightC) samples equal to 0. /*− If numInputPics is equal to 1, the following applies: *\
The luma sample array CroppedYPic[i] and the chroma sample arrays CroppedCbPic[i] and CroppedCrPic[i], when present, are set to be the 2-dimensional arrays of decoded sample values of the Y, Cb and Cr components, respectively, of sourcePic.

| | |
|---|---|
| /*- | Otherwise (numInputPics is greater than 1), the following applies: |

| | |
|---|---|
| - | The variable sourceWidth is set equal to the value of pps_pic_width_in_luma_samples − |
| | SubWidthC * ( pps_conf_win_left_offset + pps_conf_win_right_offset ) for sourcePic. |
| - | The variable sourceHeight is set equal to the value of pps_pic_height_in_luma_samples − |
| | SubHeightC * ( pps_conf_win_top_offset + pps_conf_win_bottom_offset ) for sourcePic. |
| - | If sourceWidth is equal to CroppedWidth and sourceHeight is equal to CroppedHeight, |
| | resampledPic is set to be the same as sourcePic. |
| - | Otherwise (sourceWidth is not equal to CroppedWidth or sourceHeight is not equal to |
| | CroppedHeight), the following applies: |

| | |
|---|---|
| - | There shall be an NNPF, hereafter referred to as the super resolution NNPF, that is |
| | defined by at least one NNPFC SEI message, is activated by an NNPFA SEI message |
| | for sourcePic, and has nnpfc_purpose equal to 4, nnpfcOutputPicWidth equal to |
| | CroppedWidth and nnpfcOutputPicHeight equal to CroppedHeight. |
| - | resampledPic is set to be the output of the neural-network inference of the super |
| | resolution NNPF with sourcePic being an input. |

| | |
|---|---|
| - | The luma sample array CroppedYPic[ i ] and the chroma sample arrays CroppedCbPic[ i ] |
| | and CroppedCrPic[ i ], when present, are set to be the 2-dimensional arrays of decoded |
| | sample values of the Y, Cb and Cr components, respectively, of resampledPic. |

| | |
|---|---|
| - | BitDepth_{Y} and BitDepth_{C} are both set equal to BitDepth. |
| - | ChromaFormatIdc is set equal to sps_chroma_format_idc. *\ |

The array StrengthControlVal[i] for all values of i in the range of 0 to numInputPics−1, inclusive, specifying the filtering strength control value for the input pictures for the NNPF, is derived as follows:
StrengthControlVal[i] is set equal to the value of (firstSliceQpy+QpBdOffset)+(63+QpBdOffset), where firstSliceQpy is equal to SliceQpy of the first slice of {{the cropped decoded output picture corresponding to}}inputPic[i].

There shall not be more than two NNPFC SEI messages present in a picture unit with the same value of nnpfc_id. When there are two NNPFC SEI messages present in a picture unit with the same value of nnpfc_id, these SEI messages shall have different content. When two NNPFC SEI messages with the same nnpfc_id and different content are present in the same picture unit, both of these NNPFC SEI messages shall be in the same SEI NAL unit.

### 6.2 Embodiment 2

This embodiment is for the items summarized above in Section 5: La, 1b, 1c, 2.a, 2.b, 2.b.iii, 3.a, 3.a.i, 3.a.ii, 3.a.iii, 3.a.iii.3, 4, 5, and 6. 6.2.1 The specification for H.274/VSEI

Note that the specification below for H.274/VSEI is based on JVET-AG2034-vl (publicly available herein: https://www.jvet-experts.org/doc_end_user/documents/33_Teleconference/wg11/JVET-AG2034-v1.zip). Clauses and subclauses mentioned below are as indicated below. Clauses and subclauses not mentinoed below are the same as in JVET-AG2034-vl.

In clause 4, add the following abbreviations:
PPF Post-Processing Filter
SPO SEI Processing Order

Change the title of subclause 8.28 from “Neural-network-post-filter SEI messages” to “General post-processing filtering process and neural-network-post-filter SEI messages”.

Modify subclause 8.28.1 to be as follows:

### 8.28.1 General Post-Processing Filtering Process Using PPFs

### 8.28.1.1 General

Input to this process is a bitstream BitstreamToFilter. Output of this process is a list of PPF output pictures ListPpfOutputPics.

A PPF may be indicated by an SEI message that indicates a post-processing operation and for which the payloadType value is included in the list SeiProcessingOrderSeiList, which is specified in the semantics of the SPO SEI message. For each picture, there can be multiple PPFs activated and belonging to one or more PPF processing chains. A PPF processing chain consists of a list of PPFs indicated by an SPO SEI message with a particular value of po_id. PPF processing chains are alternative to each other, i.e., at most one processing chain can be chosen to be applied.

A special PPF cascading case is defined as the case when such two PPFs are both activated for a picture: the two PPFs are both NNPFs, one of the two NNPFs has nnpfc_purpose equal to 4 and the other has multiple input pictures, and neither of the two NNPFs is associated with an SPO SEI message. In this case, the two NNPFs are implicitly considered as belonging to one processing chain, and the NNPF with nnpfc_purpose equal to 4 is applied first.

Except for the special PPF cascading case, each processing chain containing multiple PPFs is associated with an SPO SEI message with a particular value of po_id. Except for the special PPF cascading case, any PPF not associated with an SPO SEI message is in its own processing chain.

One or more PPFs in the chosen processing chain can be applied. When multiple PPFs (in the chosen processing chain) are applied, they are applied in the cascading manner, meaning that they are applied in the order indicated by the SPO SEI message associated with the chosen processing chain, and for each applied PPF that is not the last applied PPF, the output is used as the input of the next applied PPF.

First, BitstreamToFilter is decoded, and the list CroppedDecodedPictures is set to be the list of the cropped decoded pictures in output order resulted from decoding BitstreamToFilter, and the list ListPpfOutputPics is initialized to be the same as CroppedDecodedPictures.

Second, the filtering process for one picture, as specified in clause 8.28.1.2, is repeatedly invoked, in output order, for each cropped decoded picture that is in CroppedDecodedPictures and for which one or more PPFs of one or more processing chains are activated and only one of the processing chains is chosen to be applied.

The order of the pictures in ListPpfOutputPics is in output order.

Within ListPpfOutputPics there shall be no more than one picture pertaining to any particular output time instance. When for any particular picture in CroppedDecodedPictures there are PPFs of multiple processing chains activated, the above constraint shall apply regardless of which processing chain is chosen to be applied when the particular picture is the current picture.

For any particular pair of pictures inputPicA and inputPicB consecutive in output order in CroppedDecodedPictures, when there are one or more pictures intermediatePicSetA in ListPpfOutputPics between inputPicA and inputPicB in output order, the pictures in interpolatedPicSetA shall be among the pictures that were output by applying a particular PPF ppfA when a particular picture currPicA in CroppedDecodedPictures was the current picture. When the involved PPFs are all NNPFs, one and only one of the following shall apply:
The pictures in intermediatePicSetA shall be among the pictures that were output by applying a particular NNPF nnpfA with PictureRateUpsamplingFlag equal to 1 when a particular picture currPicA in CroppedDecodedPictures was the current picture.
The pictures in intermediatePicSetA shall be among the pictures that were output by applying a particular NNPF nnpfA with TemporalExtrapolationFlag equal to 1 when a particular picture currPicA in CroppedDecodedPictures was the current picture.

The application of any other PPF that was used in the filtering process for one picture when currPicA was the current picture or the application of any PPF (including ppfA) that was used in the filtering process for one picture when any other picture currPicB in CroppedDecodedPictures was the current picture shall not output any picture between the inputPicA and inputPicB in output order. NOTE—The intent of the constraints expressed in the above paragraph is to disallow generating PPF output pictures between any particular pair of consecutive input pictures more than once.

### 8.28.1.2 Filtering Process for One Picture

The filtering process specified in this subclause applies to each cropped decoded picture, referred to as the current picture, that is in CroppedDecodedPictures and for which one or more processing chains are activated, only one of the processing chains is chosen to be applied, and the number of PPFs (in the chosen processing chains) to be applied is greater than 0.

The filtering process for one picture using one PPF, as specified in subclause 8.28.1.3, is repeatedly invoked for each of the PPFs to be applied. When the number of PPFs to be applied is greater than 1, the following applies:
If the special PPF cascading case applies for the chosen processing chain, the NNPF with nnpfc_purpose equal to 4 is applied first, followed by the NNPF with multiple input pictures.
Otherwise (the special PPF cascading case does not apply for the chosen processing chain), the PPFs are applied in the preferred order indicated by the SPO SEI message associated with the chosen processing chain.

### 8.28.1.3 Filtering Process for One Picture Using a PPF

The filtering process specified in this clause applies when a particular PPF is applied when a particular picture is the current picture.

Before the PPF is applied, when the PPF is the first PPF to be applied, the list CandInputPicList is set to be identical to CroppedDecodedPictures.

When applying a PPF to the current picture, the input pictures for the PPF are selected from the list CandInputPicList, and the order of the pictures generated and output by the PPF are in output order.

When applying a PPF that is an NNPF to the current picture, the following applies:
The filtered and/or interpolated pictures are generated by the NNPF by applying the NNPF process specified in the semantics of the NNPFC SEI message, in a patch-wise manner, to the current picture.
The order of the pictures generated by the NNPF by applying the NNPF process being stored into the output tensor of the NNPF is in output order.

After the PPF is applied, the lists CandInputPicList and ListOutputPics are both updated, in the same manner, by 1) replacing each of those pictures in the list having a corresponding PPF output picture of the PPF with the corresponding PPF output picture, and 2) inserting those interpolated or extrapolated pictures, if any, into the list and placing them such that all pictures in the updated list are in output order.

### Modify Subclause 8.28.2.2 to be as Follows:

### 8.28.2.2 Neural-Network Post-Filter Characteristics SEI Message Semantics

The neural-network post-filter characteristics (NNPFC) SEI message specifies a neural network that may be used as a post-processing filter. The use of specified neural-network post-processing filters (NNPFs) for specific pictures is indicated with neural-network post-filter activation (NNPFA) SEI messages.

Use of this SEI message requires the definition of the following variables:
The list CandInputPicList that contains a list of pictures in output order from which the input pictures for the NNPF are selected.
   NOTE 1—This list is updated by the PPF filtering process each time when a PPF is applied for the current picture unless the PPF is the last PPF that is applied for the current picture.
Input picture width and height in units of luma samples, denoted herein by CroppedWidth and CroppedHeight, respectively.
Luma sample array CroppedYPic[idx] and chroma sample arrays CroppedCbPic[idx] and CroppedCrPic[idx], when present, of the input pictures with index idx in the range of 0 to numInputPics−1, inclusive, that are used as input for the NNPF.
Bit depth BitDepthY for the luma sample array of the input pictures.
Bit depth BitDepthC for the chroma sample arrays, if any, of the input pictures.
Chroma format indicator ChromaFormatldc, as described in clause 7.3, of the input pictures.
When nnpfc_auxiliary_inp_ide is equal to 1, a filtering strength control value array StrengthControlVal[idx] that shall contain real numbers in the range of 0 to 1, inclusive, of the input pictures with index idx in the range of 0 to numInputPics−1, inclusive.

Input picture with index 0 is the picture in CandInputPicList corresponding to the picture for which the NNPF defined by this NNPFC SEI message is activated by an NNPFA SEI message. Input picture with index i in the range of 1 to numInputPics−1, inclusive, precedes the input picture with index i−1 in output order.

NOTE 2—The picture in CandInputPicList corresponding to a picture is either the cropped decoded output picture of that picture or a filtered version of the cropped decoded output picture that was an output picture of a previously applied PPF.

The variables SubWidthC and SubHeightC are derived from ChromaFormatldc as specified by Table 2.

NOTE 3—More than one NNPFC SEI message can be present for the same picture. When more than one NNPFC SEI message with different values of nnpfc id is present or activated for the same picture, they can have the same value or different values of nnpfc_purpose and the same value or different values of nnpfc_mode_idc.

nnpfc_absent_input_pic_zero_flag equal to 1 indicates that the NNPF expects an input picture corresponding to a picture that is not present in the bitstream to be represented by sample arrays with sample values equal to 0. nnpfc_absent input_pic_zero_flag equal to 0 indicates that the NNPF expects an input picture inputPicA corresponding to a picture that is not present in the bitstream to be represented by the input picture inputPicB that is the closest to inputPicA in output order and the picture corresponding to inputPicB is present in the bitstream.

### Modify Subclause 8.28.3.2 to be as Follows:

### 8.28.2.3 Neural-Network Post-Filter Activation SEI Message Semantics

nnpfa_no_prev_clvs_flag equal to 1 specifies that the pictures corresponding to the input pictures for the NNPF do not originate from a previous CLVS. nnpfa_no_prev_clvs_flag equal to 0 specifies that the pictures corresponding to the input pictures for the NNPF may or may not originate from a previous CLVS.

NOTE 4—The value of nnpfa_no_prev_clvs_flag can be changed from 0 to 1, when the current CLVS is spliced from another bitstream next to the previous CLVS and this NNPFA SEI message would cause one or more input pictures to be selected that have corresponding pictures from one or more previous CLVSs and therefore is likely to impact the output of the target NNPF negatively.

nnpfa_no_foll_clvs_flag equal to 1 specifies that when this NNPFA SEI message persists for the last PU of a CLVS in output order, the NNPFA SEI message is treated like it persisted for the last PU, in output order, of the current layer within the bitstream. When this NNPFA SEI message does not persist for the last PU, in output order, of a CLVS in output order or nnpfa_no_foll_clvs_flag is equal to 0, the value of nnpfa_no_foll_clvs_flag causes no specific impact.

NOTE 5—The value of nnpfa_no_foll_clvs_flag can be changed from 0 to 1 for a picture-rate-upsampling NNPF, when the following CLVS is spliced from a different bitstream next to the current CLVS. Consequently, the NNPF process interpolates pictures up to the end of the current CLVS using input pictures corresponding to pictures originating from the current CLVS only.

### 6.2.2. The Specification for H.266/VVC

Note that the specification below for H.266/VVC is based on joint video experts team (JVET)-AG2027-vl (publicly available herein: https://www.jvet-experts.org/doc_end_user/documents/33_Teleconference/wg11/JVET-AG2027-v1.zip). Clauses and subclauses mentioned below are as indicated below. Clauses and subclauses not mentinoed below are the same as in JVET-AG2027-vl.

Replace Subclause D.11.11 with the Following:

### D.11.11 Use of the Post-Processing Filter SEI Messages, Including the Neural Network Post-Filter Characteristics SEI Message and the Neural Network Post-Filter Activation SEI Message

A post-processing filter (PPF) may be indicated by an SEI message that indicates a post-processing operation and for which the payloadType value is included in the list SeiProcessingOrderSeiList, which is specified in the semantics of the SPO SEI message.

Let currPic be the cropped decoded output picture for which the PPF, e.g., neural-network post-processing filter (NNPF) defined by the neural-network post-filter characteristics (NNPFC) SEI message, is activated, e.g., by a neural-network post-filter activation (NNPFA) SEI message, and currLayerId be the nuh_layer_id value of currPic.

The list candlnputPicList contains a list of pictures in output order from which the input pictures for the PPF are selected.

NOTE 1—This list is updated by the PPF filtering process each time when a PPF is applied for the current picture unless the PPF is the last PPF that is applied for the current picture.

When the PPF is not an NNPF, the PPF is considered to have only one input picture that is the picture in candInputPicList corresponding to the current picture.

NOTE 2—The picture in candInputPicList corresponding to a cropped decoded output picture is either the cropped decoded output picture itself or a filtered version of the cropped decoded output picture that was an output picture of a previously applied PPF.

If the PPF is the first PPF that is applied for the current picture, the following applies:
CroppedWidth is set equal to the value of pps_pic_width_in_luma samples−SubWidthC*(pps_conf_win_left_offset+pps_conf_win_right_offset) for currPic.
CroppedHeight is set equal to the value of pps_pic_height_in_luma_samples−SubHeightC*(pps_conf_win_top offset+pps_conf_win_bottom_offset) for currPic.
BitDepthy and BitDepthc are both set equal to BitDepth.
ChromaFormatIdc is set equal to sps_chroma_format_idc.

Otherwise (the PPF is not the first PPF that is applied for the current picture), the following applies:
CroppedWidth is set equal to the picture width in units of luma samples of the picture in candInputPicList corresponding to the current picture.
CroppedHeight is set equal to the picture height in units of luma samples of the picture in candInputPicList corresponding to the current picture.
BitDepthY is set equal to the bit depth BitDepthY for the luma sample array of the picture in candInputPicList corresponding to the current picture.
BitDepthC is set equal to the bit depth BitDepthC for the chroma sample arrays, if any, of the picture in candInputPicList corresponding to the current picture.
ChromaFormatIdc is set equal to the chroma format indicator ChromaFormatIdc of the the picture in candInputPicList corresponding to the current picture.

The remainder of this subclause applies when the PPF is an NNPF.

It is a requirement of bitstream conformance that when a picture unit contains an NNPFA SEI message, the value of ph_pic_output_flag in the picture header contained in that picture unit shall be equal to 1.

NOTE 3—Since when the NNPF is the first PPF that is applied for currPic only cropped decoded output pictures are used as input pictures of the NNPF, the value of ph_pic_output_flag in the picture header of the coded picture corresponding to each input picture of the NNPF is equal to 1.

The variable pictureRateUpsamplingFlag is set equal to ((nnpfc_purpose & 0×08)>0)?1:0.

The variable numInputPics is set equal to nnpfc num_inputpics_minus1+1.

The variable numInferences is derived as follows:
If all of the following conditions are true, the variable numPostRoll is set equal to the value of i such that nnpfc_interpolated_pics[i] is greater than 0 and the variable numInferences is set equal to 1+numPostRoll:
   nnpfc_purpose is equal to 8 (i.e., the only purpose for the NNPF is picture rate upsampling).
   nnpfa_persistence_flag is equal to 1.
   nnpfc_interpolated_pics[i] is greater than 0 only for a single value of i that is greater than 0.
   Either of the following conditions is true:
      currPic is the last picture of the bitstream in output order that has nuh_layer_id equal to currLayerId.
      currPic is the last picture in the CLVS in output order and nnpfa_no_foll_clvs_flag is equal to 1.
Otherwise, if all of the following conditions are true, the variable numPostRoll is set equal to InpIdx[i] for the value of i such that nnpfa_output_flag[i] is equal to 1, and the variable numInferences is set equal to 1+numPostRoll:
   pictureRateUpsamplingFlag is equal to 0.
   numInputPics is greater than 1.
   nnpfa_persistence_flag is equal to 1.
   nnpfa_output_flag[idx] is equal to 1 for a single value of idx in the range of 0 to NumInpPicsInOutputTensor −1, inclusive, and for that single value of idx, InpIdx[idx] is greater than 0.
   Either of the following conditions is true:
      currPic is the last picture of the bitstream in output order that has nuh_layer_id equal to currLayerId.
      currPic is the last picture in the CLVS in output order and nnpfa_no_foll_clvs_flag is equal to 1.
Otherwise, the variable numInferences is set equal to 1.

For each value of j in the range of 0 to numInferences −1, inclusive, the following applies for the derivation of the input pictures for the NNPF such that each input picture is a picture in candlnputPicList:
The arrays inputPic[i] and inputPresentFlag[i] for i in the range of 0 to numInputPics−1, inclusive, representing all the input pictures and the presence of input pictures, respectively, are specified as follows:
   When j is greater than 0, for each value of k in the range of 0 to j−1, inclusive, inputPic[k] is set to be the picture in candlnputPicList corresponding to currPic and inputPresentFlag[k] is set equal to 0.
   The j-th input picture, inputPic[j], is set to be the picture in candlnputPicList corresponding to currPic and inputPresentFlag[j] is set equal to 1.
   When numInputPics is greater than 1, the following applies for each value of i in the range of j+1 to numInputPics−1, inclusive, in increasing order of i:
      If both of the following conditions are true, inputPic[i] is set to be the picture in candlnputPicList corresponding to prevPic and inputPresentFlag[i] is set equal to 1:
         Either of the following conditions is true:
         pictureRateUpsamplingFlag is equal to 1 and currPic is associated with a frame packing arrangement SEI message with frame_packing_arrangement_type equal to 5 and a particular value of fp_current_frame_is_frame0_flag, and there is a cropped decoded output picture prevPic that is the last picture in output order among all cropped decoded output pictures that have nuh_layer_id equal to currLayerId, precede inputPic[i−1] in output order, and are associated with a frame packing arrangement SEI message with frame_packing_arrangement_type equal to 5 and the same value of fp_current_frame_is_frame0 flag.
         pictureRateUpsamplingFlag is equal to 0 or currPic is not associated with a frame packing arrangement SEI message with frame_packing_arrangement_type equal to 5, and there is a cropped decoded output picture prevPic that is the last picture in output order among all cropped decoded output pictures that have nuh_layer_id equal to currLayerId and precede inputPic[i−1] in output order.
         nnpfa_no_prev_clvs_flag is equal to 0 or the coded picture corresponding to prevPic and the current picture are present in the same CLVS.
      Otherwise, the following applies:
         inputPic[i] is set to be the same picture as inputPic[i−1] and inputPresentFlag[i] is set equal to 0.
         It is a requirement of bitstream conformance that, when pictureRateUpsamplingFlag is equal to 1, nnpfc_interpolated_pics[i−1] shall be equal to 0.
         It is a requirement of bitstream conformance that when inputPresentFlag[i] is equal to 0 and nnpfc_input_pic_output_flag[i] is equal to 1, the value of nnpfa_output_flag[idx] shall be equal to 0 for the value of idx such that InpIdx[idx] is equal to i.
For purposes of interpretation of the NNPFC SEI message, the following variables are specified:
   The luma sample arrays CroppedYPic[i] and the chroma sample arrays CroppedCbPic[i] and CroppedCrPic[i], when present, are derived as follows for each value of i in the range of 0 to numInputPics−1, inclusive:
      The variable sourcePic is derived as follows:
         If inputPresentFlag[i] is equal to 1 or nnpfc_absent input_pic_zero_flag is equal to 0, sourcePic is set to be inputPic[i].
         Otherwise(inputPresentFlag[i] is equal to 0 and nnpfc_absent input_pic_zero_flag is equal to 1), sourcePic is set to be apicture with a luma sample array of CroppedWidth×CroppedHeight samples equal to 0 and Cb and Cr sample arrays of (CroppedWidth/SubWidthC)×(CroppedHeight/SubHeightC) samples equal to 0.
   The luma sample array CroppedYPic[i] and the chroma sample arrays CroppedCbPic[i] and CroppedCrPic[i], when present, are set to be the 2-dimensional arrays of decoded sample values of the Y, Cb and Cr components, respectively, of sourcePic.
The array StrengthControlVal[i] for all values of i in the range of 0 to numInputPics−1, inclusive, specifying the filtering strength control value for the input pictures for the NNPF, is derived as follows:
   StrengthControlVal[i] is set equal to the value of (firstSliceQpy+QpBdOffset)+(63+QpBdOffset), where firstSliceQpy is equal to SliceQpy of the first slice of the cropped decoded output picture corresponding to inputPic[i].

There shall not be more than two NNPFC SEI messages present in a picture unit with the same value of nnpfc_id. When there are two NNPFC SEI messages present in a picture unit with the same value of nnpfc_id, these SEI messages shall have different content. When two NNPFC SEI messages with the same nnpfc_id and different content are present in the same picture unit, both of these NNPFC SEI messages shall be in the same SEI NAL unit.

### 7. REFERENCES

[1] ITU-T and ISO/IEC, “High efficiency video coding”, Rec. ITU-T H.265 I ISO/IEC 23008-2 (in force edition).
[2] ITU-T and ISO/IEC, “Versatile Video Coding”, Rec. ITU-T H.266| ISO/IEC 23090-3.
[3] ITU-T and ISO/IEC, “Versatile Supplemental Enhancement Information Messages for Coded Video Bitstreams”, Rec. ITU-T Rec. H.274 ISO/IEC 23002-7.
[4]S. McCarthy, M. M. Hannuksela, and Y.-K. Wang (eds), JVET-AE2027, “SEI processing order SEI message in VVC (draft 5)”
[5]S. McCarthy, T. Chujoh, M. Hannuksela, G. J. Sullivan, and Y.-K. Wang (editors), “Additional SEI messages for VSEI (Draft 5)”, WET output document JVET-AE2006, publicly available online herein: https://jvet-experts.org/doc_end_user/current_document.php?id=13271.
[6]B. Bross, E. Frangois, M. M. Hannuksela, A. Tourapis, and Y.-K. Wang (editors), “New level and systems-related supplemental enhancement information for VVC (Draft 6)”, WET output document JVET-AE2005, publicly available online herein: https://jvet-experts.org/doc_end_user/current_document.php?id=13270.

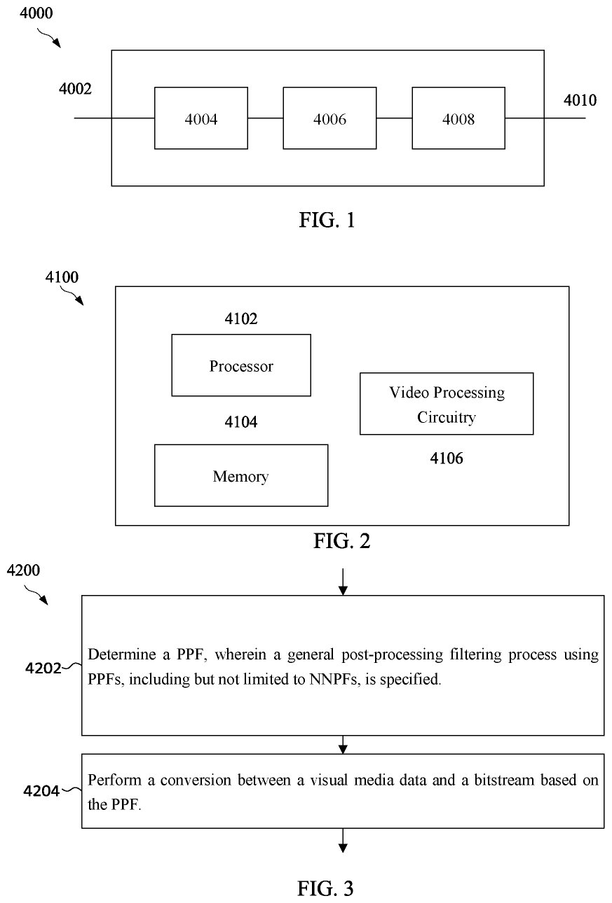

FIG. 1 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, aperipheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 2 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 3 is a flowchart for an example method 4200 of video processing. The method 4200 determines a post-processing filter (PPF), wherein a general post-processing filtering process using PPFs, including but not limited to NNPFs, is specified at step 4202. A conversion between a visual media data and a bitstream is perfomed based on the PPF at step 4204. The conversion may include encoding at an encoder, decoding at a decoder, or combinations thereof.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

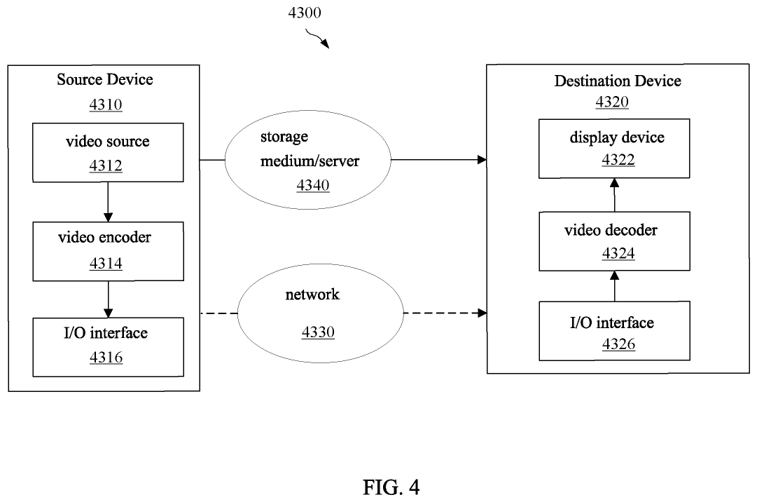

FIG. 4 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

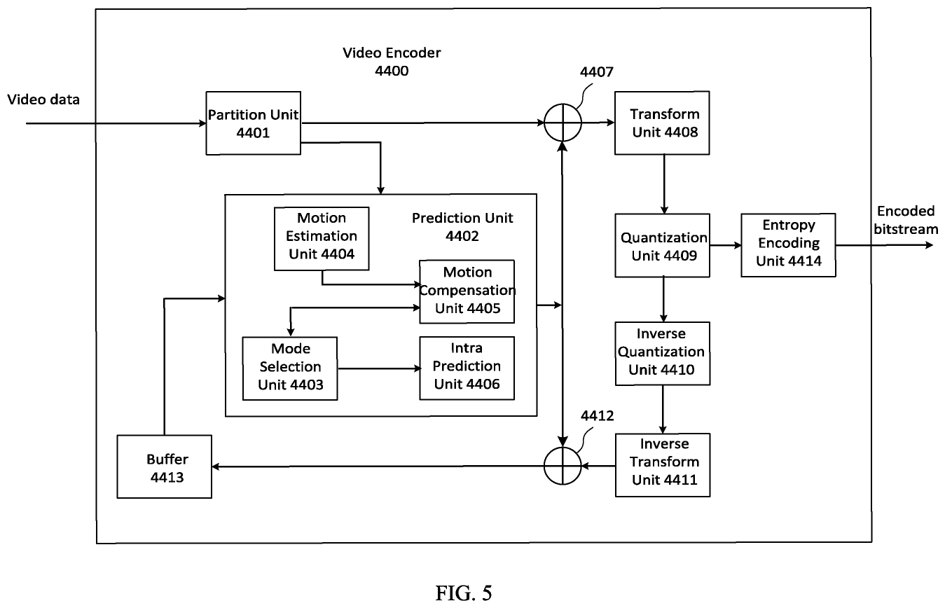

FIG. 5 is a block diagram illustrating an example of video encoder 4400, which may be video encoder 4314 in the system 4300 illustrated in FIG. 4. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

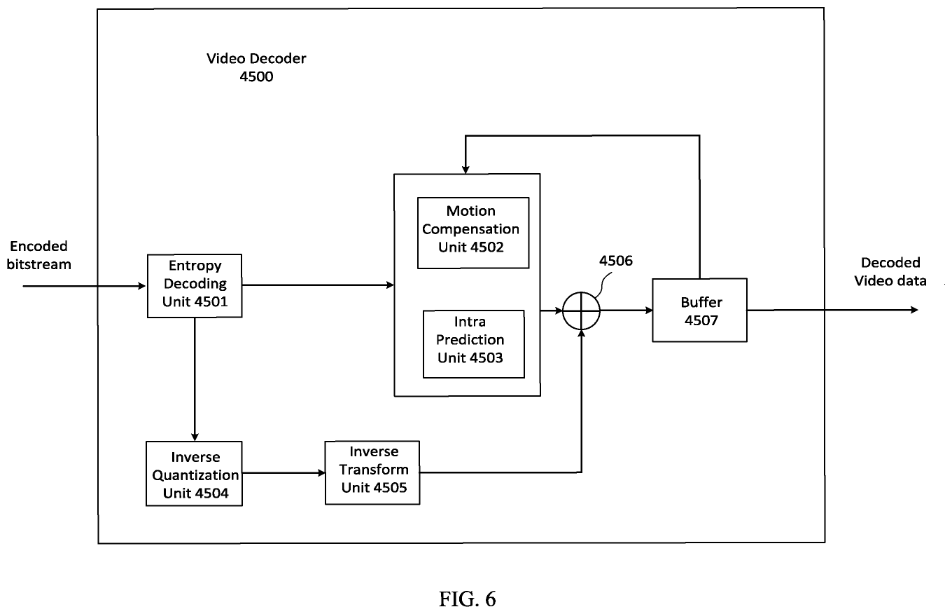

FIG. 6 is a block diagram illustrating an example of video decoder 4500 which may be video decoder 4324 in the system 4300 illustrated in FIG. 4. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

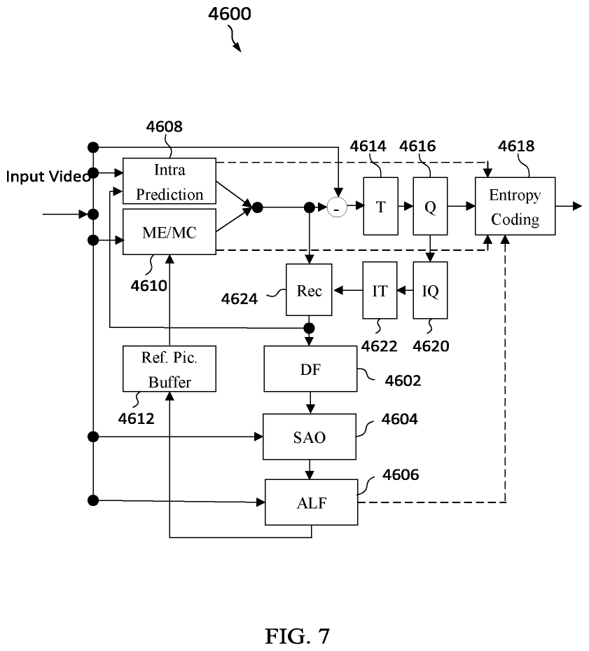

FIG. 7 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

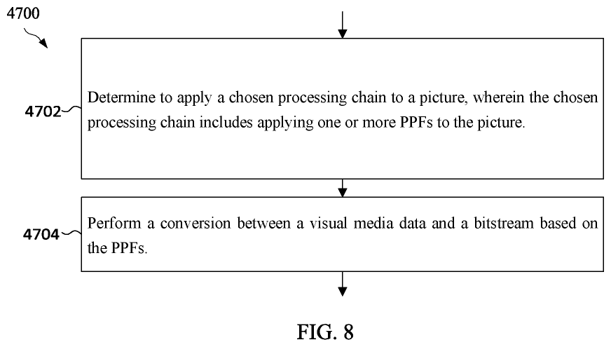

FIG. 8 is a flowchart for an example method 4700 of video processing. The method 4700 determines to obtain a list of output pictures from a processing chain, wherein the list of output pictures can include more pictures than are output by a last post-processing filter (PPF) in the processing chain at step 4702. A conversion between a visual media data and abitstream is perfomed based on the processing chain at step 4704. The conversion may include encoding at an encoder, decoding at a decoder, or combinations thereof.

It should be noted that the method 4700 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4700. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4700.

A listing of solutions preferred by some examples is provided next.

The following solutions show examples of techniques discussed herein.
1. A method for processing media data comprising: determining a post-processing filter (PPF), wherein a general post-processing filtering process using PPFs, including but not limited to NNPFs, is specified; and performing a conversion between a visual media data and a bitstream based on the PPF.
2. The method of solution 1, wherein PPFs are grouped, PPFs groups are alternative to each other such that only one PPF group may be chosen to be applied for any particular picture.
3. The method of any of solutions 1-2, wherein PPFs within the chosen PPF group are applied in the cascading manner such that the output of one PPF is used as the input of the PPF to be applied next.
4. The method of any of solutions 1-3, wherein regardless of how many PPFs in the chosen PPF group are to be applied for a current picture, and regardless of what types of PPFs are those, it is allowed for output pictures by an earlier applied PPF to be used as input pictures by a later applied PPF.
5. The method of any of solutions 1-4, wherein a list CandInputPicList that includes all candidates for input pictures is initialized or reset to contain the list of the cropped decoded pictures in output order resulted from decoding BitstreamToFilter for each current picture before applying the first PPF for the current picture, and is updated each time when a PPF is applied, possibly except for the PPF that is last applied for the current picture.
6. The method of any of solutions 1-5, wherein after an PPF is applied for the current picture, the list CandInputPicList is updated by replacing each of those pictures in the list having a corresponding PPF output picture of the PPF with the corresponding PPF output picture.
7. The method of any of solutions 1-6, wherein before an PPF is applied for the current picture, the list CandInputPicList is updated by replacing each of those pictures in the list having a corresponding PPF output picture of the PPF and before the current picture in output order with the corresponding PPF output picture.
8. The method of any of solutions 1-7, wherein after an PPF is applied for the current picture, the list CandlnputPicList is updated by inserting those interpolated pictures, if any, into the list and placing them such that all pictures in the updated list are in output order.
9. The method of any of solutions 1-8, wherein after an PPF is applied for the current picture, the list CandlnputPicList is updated by both replacing each of those pictures in the list having a corresponding PPF output picture of the PPF with the corresponding PPF output picture, and inserting those interpolated pictures, if any, into the list and placing them such that all pictures in the updated list are in output order.
10. The method of any of solutions 1-9, wherein it is specified that the output of the general post-processing filtering process is a list of output pictures ListOutputPics that can include more pictures that are output by the last applied PPF.
11. The method of any of solutions 1-10, wherein the list ListOutputPics can include cropped decoded pictures that do not have corresponding output pictures that are output by any applied PPF, or wherein the list ListOutputPics can include PPF output pictures that are output by an PPF that is not the last PPF applied when a particular picture is the current picture.
12. The method of any of solutions 1-11, wherein the list ListOutputPics is initialized, before the application of any PPF, to contain the list of the cropped decoded pictures in output order resulted from decoding BitstreamToFilter, and is updated each time when a PPF is applied.
13. The method of any of solutions 1-12, wherein after an PPF is applied, the list ListOutputPics is updated by replacing each of those pictures in the list having a corresponding PPF output picture of the PPF with the corresponding PPF output picture.
14. The method of any of solutions 1-13, wherein after an PPF is applied, the list ListOutputPics is updated by inserting those interpolated pictures, if any, into the list and placing them such that all pictures in the updated list are in output order.
15. The method of any of solutions 1-14, wherein after an PPF is applied, the list ListOutputPics is updated by both replacing each of those pictures in the list having a corresponding PPF output picture of the PPF with the corresponding PPF output picture, and inserting those interpolated pictures, if any, into the list and placing them such that all pictures in the updated list are in output order.
16. An apparatus for processing video data comprising: a processor; and a non-transitory memory with instructions thereon, wherein the instructions upon execution by the processor, cause the processor to perform the method of any of solutions 1-15.
17. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-15.
18. A non-transitory computer-readable recording medium storing a bitstream of a video which is generated by a method performed by a video processing apparatus, wherein the method comprises: determining a post-processing filter (PPF), wherein a general post-processing filtering process using PPFs, including but not limited to NNPFs, is specified; and generating a bitstream based on the determining.
19. A method for storing bitstream of a video comprising: determining a post-processing filter (PPF), wherein a general post-processing filtering process using PPFs, including but not limited to NNPFs, is specified; generating a bitstream based on the determining; and storing the bitstream in a non-transitory computer-readable recording medium.
20. A method, apparatus, or system described in the present document.

The following solutions show further examples of techniques discussed herein.
1. A method for processing media data comprising: determining to obtain a list of output pictures from a processing chain, wherein the list of output pictures can include more pictures than are output by a last post-processing filter (PPF) in the processing chain; and performing a conversion between a visual media data and a bitstream based on the processing chain.
2. The method of claim 1, wherein the list can include cropped decoded pictures that do not have corresponding output pictures that are output by any applied PPF.
3. The method of any of claims 1-2, wherein the list can include PPF output pictures that are output by a PPF that is not a last PPF applied to a current picture.
4. The method of any of claims 1-3, wherein when a picture in the list is replaced, properties of the picture are also updated as part of the list, and wherein properties that are updated include picture width in units of luma samples, picture height in units of luma samples, bit depth for the luma sample array of the picture, bit depth for the chroma sample arrays of the picture, chroma format indicator of the picture, or combinations thereof.
5. The method of any of claims 1-4, wherein when a picture is inserted into the list, properties of the picture are also updated as part of the list, and wherein properties that are updated include picture width in units of luma samples, picture height in units of luma samples, bit depth for the luma sample array of the picture, bit depth for the chroma sample arrays of the picture, chroma format indicator of the picture, or combinations thereof.
6. The method of any of claims 1-5, wherein after aPPF is applied, the list is updated by 1) replacing each of those pictures in the list having a corresponding PPF output picture of the PPF with the corresponding PPF output picture, and 2) inserting interpolated or extrapolated pictures, if any, into the list and placing the interpolated or extrapolated pictures such that all pictures in the updated list are in output order.
7. The method of any of claims 1-6, wherein the list is initialized, before the application of any PPF, to contain a list of the cropped decoded pictures in output order resulting from decoding the bitstrem, and is updated each time when a PPF is applied.
8. The method of any of claims 1-7, wherein after a PPF is applied, the list is updated by replacing each of those pictures in the list having a corresponding PPF output picture of the PPF with the corresponding PPF output picture.
9. The method of any of claims 1-8, wherein after a PPF is applied, the list is updated by inserting those interpolated pictures, if any, into the list and placing them such that all pictures in the updated list are in output order
10. The method of any of claims 1-9, wherein after an PPF is applied, the list is updated by both replacing each of those pictures in the list having a corresponding PPF output picture of the PPF with the corresponding PPF output picture, and inserting those interpolated pictures, if any, into the list and placing them such that all pictures in the updated list are in output order.
11. The method of any of claims 1-10, wherein a PPF may be indicated by an supplemental enhancement information (SEI) message that indicates a post-processing operation and for which the payload type (payloadType) value is included in the list SEI processing order SEI list (SeiProcessingOrderSeiList), which is specified by a SEI processing order (SPO) SEI message.
12. The method of claim 1-11, wherein the processing chain is applied by decoding the list of cropped decoded pictures in output order, choosing the processing chain, applying each PPF in the processing chain to each cropped decoded picture in the list, and replacing cropped decoded pictures in the list with processed pictures.
13. The method of any of claims 1-12, wherein the conversion includes encoding the visual media data into the bitstream.
14. The method of any of claims 1-12, wherein the conversion includes decoding the visual media data from the bitstream.
15. A non-transitory computer-readable recording medium storing a bitstream of a video which is generated by a method performed by a video processing apparatus, wherein the method comprises: determining to obtain a list of output pictures from a processing chain, wherein the list of output pictures can include more pictures than are output by a last post-processing filter (PPF) in the processing chain; and generating a bitstream based on the determining.
16. The non-transitory computer-readable recording medium of claim 15, wherein the list can include cropped decoded pictures that do not have corresponding output pictures that are output by any applied PPF.
17. The non-transitory computer-readable recording medium of any of claims 15-16, wherein the list can include PPF output pictures that are output by a PPF that is not a last PPF applied to a current picture.
18. A method for storing bitstream of a video comprising: determining to obtain a list of output pictures from a processing chain, wherein the list of output pictures can include more pictures than are output by a last post-processing filter (PPF) in the processing chain; generating a bitstream based on the determining; and storing the bitstream in a non-transitory computer-readable recording medium.
19. The method of claim 18, wherein the list can include cropped decoded pictures that do not have corresponding output pictures that are output by any applied PPF.
20. The method of any of claims 18-19, wherein the list can include PPF output pictures that are output by a PPF that is not a last PPF applied to a current picture.
21. An apparatus for processing video data comprising: a processor; and a non-transitory memory with instructions thereon, wherein the instructions upon execution by the processor, cause the processor to perform the method of any of claims 1-14.
22. A non-transitory computer readable medium comprising a computer program product for use by a video coding device, the computer program product comprising computer executable instructions stored on the non-transitory computer readable medium such that when executed by a processor cause the video coding device to perform the method of any of claims 1-14.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including+10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
performing a conversion between the media data and a bitstream of the media data according to a rule,
wherein the rule specifies that for applying a processing chain, a first list is set to be a list of cropped decoded pictures in output order that resulted from decoding the bitstream, and the processing chain is chosen, and
wherein the first list is updated to a second list when a process in the processing chain implied by a supplemental enhancement information (SEI) message is performed, and the second list is allowed to include more pictures than pictures that are output by a last process in the process chain.

2. The method of claim 1, wherein the second list is allowed to include cropped decoded pictures that do not have corresponding output pictures that are output by any process in the processing chain.

3. The method of claim 1, wherein the second list is allowed to include output pictures that are output by a process that is not a last process in the processing chain applied to a current picture.

4. The method of claim 1, wherein the rule further specifies that when the process implied by the SEI message is performed, the first list is updated by replacing pictures with corresponding processed pictures, if any, resulting from the process and inserting other pictures, if any, resulting from the process into the first list so that the output order is obeyed.

5. The method of claim 1, wherein when a first picture in the second list is replaced, properties of the first picture are updated.

6. The method of claim 5, wherein properties that are updated include at least one of picture width in units of luma samples, picture height in units of luma samples, bit depth for a luma sample array of the first picture, bit depth for a chroma sample array of the first picture, or chroma format indicator of the first picture.

7. The method of claim 1, wherein when a second picture is inserted into the second list, properties of the second picture are stored.

8. The method of claim 7, wherein properties that are stored include at least one of picture width in units of luma samples, picture height in units of luma samples, bit depth for a luma sample array of the second picture, bit depth for a chroma sample array of the second picture, or chroma format indicator of the second picture.

9. The method of claim 1, wherein the processing chain consists of a list of types of SEI messages identified by an an SEI processing order (SPO) SEI message in a preferred processing order indicated in the SPO SEI message.

10. The method of claim 1, wherein the conversion includes encoding the media data into the bitstream.

11. The method of claim 1, wherein the conversion includes decoding the media data from the bitstream.

12. An apparatus for processing media data comprising: a processor; and a non-transitory memory with instructions thereon, wherein the instructions upon execution by the processor, cause the processor to:
perform a conversion between the media data and a bitstream of the media data according to a rule,
wherein the rule specifies that for applying a processing chain, a first list is set to be a list of cropped decoded pictures in output order that resulted from decoding the bitstream, and the processing chain is chosen, and
wherein the first list is updated to a second list when a process in the processing chain implied by a supplemental enhancement information (SEI) message is performed, and the second list is allowed to include more pictures than pictures that are output by a last process in the process chain.

13. The apparatus of claim 12, wherein the second list is allowed to include cropped decoded pictures that do not have corresponding output pictures that are output by any process in the processing chain.

14. The apparatus of claim 12, wherein the second list is allowed to include output pictures that are output by a process that is not a last process in the processing chain applied to a current picture.

15. The apparatus of claim 12, wherein the rule further specifies that when the process implied by the SEI message is performed, the first list is updated by replacing pictures with corresponding processed pictures, if any, resulting from the process and inserting other pictures, if any, resulting from the process into the first list so that the output order is obeyed.

16. A non-transitory computer-readable storage medium storing instructions that cause a processor to:
perform a conversion between media data and a bitstream of the media data according to a rule,
wherein the rule specifies that for applying a processing chain, a first list is set to be a list of cropped decoded pictures in output order that resulted from decoding the bitstream, and the processing chain is chosen, and
wherein the first list is updated to a second list when a process in the processing chain implied by a supplemental enhancement information (SEI) message is performed, and the second list is allowed to include more pictures than pictures that are output by a last process in the process chain.

17. The non-transitory computer-readable storage medium of claim 16, wherein the second list is allowed to include cropped decoded pictures that do not have corresponding output pictures that are output by any process in the processing chain.

18. The non-transitory computer-readable storage medium of claim 16, wherein the second list is allowed to include output pictures that are output by a process that is not a last process in the processing chain applied to a current picture.

19. A non-transitory computer-readable recording medium storing a bitstream of media data which is generated by a method performed by a video processing apparatus, wherein the method comprises:
generating the bitstream of media data according to a rule,
wherein the rule specifies that for applying a processing chain, a first list is set to be a list of cropped decoded pictures in output order that resulted from decoding the bitstream, and the processing chain is chosen, and
wherein the first list is updated to a second list when a process in the processing chain implied by a supplemental enhancement information (SEI) message is performed, and the second list is allowed to include more pictures than pictures that are output by a last process in the process chain.

20. The non-transitory computer-readable recording medium of claim 19, wherein the second list is allowed to include cropped decoded pictures that do not have corresponding output pictures that are output by any process in the processing chain.
